(19) United States
(12) Patent Application Publication
(10) Pub. No.: US 2025/0204566 A1
(43) Pub. Date: Jun. 26, 2025

(54) PLANT-ONLY GUMS (2) REPLACEMENT SYSTEM IN FOOD PRODUCTS

(71) Applicant: The Live Green Group, Inc.,, Middletown, DE (US)

(72) Inventors: Sasikanth Chemalamudi, San Fernando (CL); Priyanka Srinivas, San Fernando (CL)

(21) Appl. No.: 18/850,084

(22) PCT Filed: May 11, 2023
(86) PCT No.: PCT/IB2023/054869

§ 371 Date: Sep. 27, 2024

(30) Foreign Application Priority Data
May 12, 2022 (US) 63/341028
May 11, 2023 (WO) PCT/IB2023/054869

(51) Int. Cl. A23L 29/212; A23J 3/14; A23L 29/231

(52) U.S. Cl. CPC A23L 29/212; A23J 3/14; A23L 29/231

(57) ABSTRACT

The present disclosure discloses a plant-only composition for a food product. The plant-only composition comprises (i) about 1% to about 30% weight by weight of one or more plant-derived protein and starch sources, (ii) about 5% to about 35% weight by weight of one or more plant-derived cereal starch, (iii) about 10% to about 40% weight by weight of one or more pectin sources, and (iv) about 1% to about 35% weight by weight of one or more legume sources. The plant-only composition substitutes a gum ingredient in the food product. The food product comprises ice cream, pasta, processed cheese, tomato ketchup, soups, pastry ices, soft viscous candies, fruit-based and membrane-coated items, burgers, burger mixes, sausages, cakes, chocolate bars, pancake mixes, Traditional Burger Products, a baked good, a plant-only burger products, or another food product.

### CROSS-REFERENCE TO RELATED APPLICATIONS

This application claims priority to the U.S. provisional patent application No. 63/341,028, filed on May 12, 2022 and PCT provisional patent application no.: PCT/IB2023/054869, filed on May 11, 2023, titled “PLANT-ONLY GUMS (2) REPLACEMENT SYSTEM IN FOOD PRODUCTS” and is incorporated herein by reference.

### BACKGROUND

### Technical Field

The present disclosure relates to plant-only gum replacement system, replacing the chemical, synthetic and/or highly processed gum additives in commercially available food products such as animal-based or plant-based burgers, burger mixes, other meat-based products, meat alternative products, frozen food products, baked goods and other food products, including food product mixes in which the functionality of one or more gums may be desired to improve texture and stability of a food product. Such plant-only replacements are minimally processed and are free of synthetic food additives.

### Description of the Related Art

Many commercially available, processed plant-based and animal-based food products contain natural and/or synthetic food additives as well as other highly processed ingredients. The categories of commercially available food products containing such additives vary greatly, and include animal flesh-based (i.e., any one or more of beef, pork, poultry, fish, shellfish, other seafood, etc.) or imitation meat-containing products based in whole or in part on plant-derived materials, or food products comprised of a combination both animal-source and plant-sourced materials. As an example, these food products may be, in one form, commercially available burgers and burger mixes, patties, cakes, crumbles, etc. Additives are found in all types of commercially available food products, and serve as stabilizers, preservatives, colorants, flavor enhancers, sweeteners, thickeners, texturizers, and emulsifiers, and provide a variety of desired characteristics such as flavors, textures, appearance, and consistency. Additives can maximize yield, minimize shrinkage and cooking loss, texturize, thicken, stabilize, emulsify, bind, and/or lead to more uniform blending or homogeneity to the food product or food product mix.

Together, all of the meat-based and/or plant-based meat alternative food products available commercially in any form will be referred to as “Traditional Burger Products,” despite their origin or form. These are distinguished from the plant-only burgers and burger mixes, collectively, plant-only “burger products,” as well as the plant-only gum replacement system of the disclosed embodiments. These terms are discussed in more detail and the categories distinguished further below.

Commercially available, Traditional Burger Products are generally highly processed foods. Traditional, meat-based burgers contain meat or animal flesh of some kind, added saturated fats, bone (carcass), highly processed ingredients, synthetic additives and other ingredients that may be inappropriate for certain diets, e.g., vegetarian, vegan, salt-restricted, low-fat, low saturated fat, culturally- or religiously-restricted diets etc. Even some commercially available “plant-based,” “plant-derived,” “meatless,” and “meat-free” burgers and other food products (depending on how those terms are defined by the manufacturers, or under definitions supported by a governmental authority in the location of manufacture) may contain animal-derived ingredients such as bone and meat broth or gelatin, dairy products and certain saturated fats, sourced from animals slaughtered for food, or from animals raised primarily for dairy product production. Such animal-derived additions can render even these “plant-based” burgers and burger mixes inappropriate for vegetarians and vegans.

Some meat substitutes have been developed, in part, to mimic the qualities that some consumers of plant-based alternatives desire in a burger: a juicy center, red color and meaty (or umami) taste but often a significant amount of saturated fat must be added to achieve a desired consistency or texture. Food additives in Traditional Burger Products may have physiological effects many consumers do not want or do not want to risk if a healthier, more sustainable alternative is available that does not pose the downsides. Examples of food additives commonly found in Traditional Burger Products include silicon dioxide, sodium benzoate, sodium nitrite, and artificial food colors. Many such additives (particularly synthetic additives) can be harmful to consumers if consumed over prolonged periods. The food industry uses more than 7,000 synthetic and ultra-processed additives even though nature offers more than ten million compounds from more than 450,000 plants.

Gums (hydrocolloids) are additives and are commonly used to bind ingredients together, emulsify, stabilize, help retain moisture and thicken, modifying the textural and structural properties of the food products in which they are used. Gums commonly used as additives in the food industry include, among others, carrageenan gum, which helps retain moisture in a food product, gum arabica, which increases moisture retention, guar gum, which improves cooking yield and consistency and acts as a binding agent, and xanthan gum, which also improves cooking yield. Konjac gum and starches are also commonly used. When gums come into contact with water, they form a gel; they modulate the thickening, emulsifying, smoothing, and gelling properties of aqueous foods. Gums traditionally used in meat-based burgers include those listed above, as well as gum tragacanth, gum from Detarium mirocanepum and gum from Mucuna flagellipes. Gums traditionally used in so-called plant-based burgers include (in addition to guar gum and carrageenan gum), gellan gum (thickener, binder and stabilizer), locust bean gum (structure, firmness, and heat stability), acacia and oat gums (texturizer, emulsifier and stabilizer), mucilaginous gum/flax gel (moisture retention, binding), and methylcellulose (binding, improvement of consistency, texturizer).

It would be desirable to provide solely plant-derived or fungi-derived (hereafter, “plant-only,” as further defined below) ingredients that replace highly processed, synthetic, artificial and/or animal-derived (i.e., sourced directly or indirectly from an animal) gums found in meats and meat substitutes such as Traditional Burger Products, as well as in breads and other baked goods. A “plant-only” food product is free from dairy and other animal-derived ingredients and is minimally processed, with—or, as a component of another food product, contributing to—a desirable flavor, taste, texture, homogeneity, consistency, color and appearance so as to be aesthetically pleasing to consumers.

Thus, there is a need for a plant-only composition for a food product to substitute a gum ingredient in the food product.

### SUMMARY

In view of the foregoing, embodiments herein provide a plant-only composition for a food product. The plant-only composition comprises (i) about 1% to about 30% weight by weight of one or more plant-derived protein and starch sources, (ii) about 5% to about 35% weight by weight of one or more plant-derived cereal starch, (iii) about 10% to about 40% weight by weight of one or more pectin sources, and (iv) about 1% to about 35% weight by weight of one or more legume sources. The plant-only composition substitutes a gum ingredient in the food product.

In some embodiments, the one or more plant-derived protein and starch sources comprises at least one of quinoa flour, licorice root flour, almond flour, bamboo seeds flour, Jackfruit seed flour, oats flour, Arrowroot powder, Yam flour, mung bean flour, soy flour, or a combination thereof. In some embodiments, the quinoa flour comprises (i) protein that provides structure to the food product and (ii) starch which has about 11% amylose content with small granules ranging from 1-3 micrometres (μm). The quinoa flour has low pasting temperature and high freeze-thaw stability and acts as a thickener. The quinoa flour comprises saponins that has antioxidant activity.

In some embodiments, the one or more plant-derived protein and starch sources present in the plant-only composition ranges from about 5% to about 20% weight by weight of the composition. In some embodiments, the one or more plant-derived protein and starch sources present in the plant-only composition ranges from (i) about 1% to about 5% weight by weight of the composition, (ii) about 5% to about 10% weight by weight of the composition, (iii) about 5% to about 20% weight by weight of the composition, (iv) about 10% to about 20% weight by weight of the composition, (v) about 15% to about 20% weight by weight of the composition, (vi) about 20% to about 25% weight by weight of the composition, or (vii) about 25% to about 30% weight by weight of the composition.

In some embodiments, the one or more plant-derived protein and starch sources has a gelatinization/pasting temperature of about 68.6° C. to about 69.3° C., a peak viscosity of about 0.1 and about 0.9 pascal seconds (Pa·s) at a shear rate of 115 inverse second (s⁻¹), a water holding capacity of about 415.13% to about 595.26%, an emulsion stability of about 35% to about 90%, a swelling power ranging from 20.76% to 26.92%, a moisture content of about 12.6%, a bulk density of about 0.72 gram per millilitre (g/mL), an emulsion capacity of about 100%, a foaming capacity of about 17%, a water soluble index of about 11.5% to about 13% and a peak viscosity of about 1696 millipascal seconds (mPa·s) to about 2560 mPa·s.

In some embodiments, the one or more plant-derived cereal starch comprises at least one of rice starch, sorghum starch, maize starch, wheat starch, barley starch, pearl millet starch, ragi flour, finger millet starch, oats starch, rye starch, or a combination thereof. In some embodiments, the rice starch comprises amylose and amylopectin in a ratio of 20:80 and has a particle size ranging from 1 to 100 μm. In some embodiments, the one or more plant-derived cereal starch present in the plant-only composition ranges from about 15% to about 25% weight by weight of the composition.

In some embodiments, the one or more plant-derived cereal starch present in the plant-only composition ranges from (i) about 5% to about 10% weight by weight of the composition, (ii) about 10% to about 15% weight by weight of the composition, (iii) about 15% to about 20% weight by weight of the composition, (iv) about 15% to about 25% weight by weight of the composition, (v) about 20% to about 25% weight by weight of the composition, (vi) about 25% to about 30% weight by weight of the composition, or (vii) about 30% to about 35% weight by weight of the composition.

In some embodiments, the one or more plant-derived cereal starch has a gelatinization/pasting temperature of about 68° C. to about 72° C., a peak viscosity of about 1296 centipoise (cP) to about 3348 cP, a water holding capacity of about 2.42 grams water per gram (g/g) to about 3.35 g/g, an amylose content of about 14% to about 30% and a swelling power ranging from 3.3 g/g to 8.8 g/g, a molecular weight of about 5.4×10⁷ gram per molar (g/mol) and a particle size distribution ranging about 1 micron (μm) to about 100 μm.

In some embodiments, the one or more pectin sources comprises at least one of apple pomace, jujube pomace, redcurrant pectin, blackberry pectin, strawberry pectin, orange pomace, dragon fruit peel pectin, raspberry pectin, or a combination thereof. In some embodiments, the apple pomace comprises methyl cellulose pectin that forms a thermo-irreversible gel which remains gelled even when heated to its melting temperatures. The apple pomace has insoluble fibers that maintain emulsion stability through a pickering mechanism and network formation in the continuous phase by stabilization of proteins and pectins in the soluble fraction.

In some embodiments, the one or more pectin sources present in the plant-only composition ranges from about 20% to about 30% weight by weight of the composition. In some embodiments, the one or more pectin sources present in the plant-only composition ranges from (i) about 10% to about 15% weight by weight of the composition, (ii) about 15% to about 20% weight by weight of the composition, (iii) about 20% to about 25% weight by weight of the composition, (iv) about 25% to about 30% weight by weight of the composition, (v) about 20% to about 30% weight by weight of the composition, (vi) about 30% to about 35% weight by weight of the composition, or (vii) about 35% to about 40% weight by weight of the composition.

In some embodiments, the one or more pectin sources has an emulsion stability of about 35% to about 80%, an oil holding capacity of 2.97 grams of oil per gram (g/g) to about 11 g/g, a water holding capacity of about 3 grams water per gram (g/g) to about 17 g/g, a pH of about 3.9, a molecular weight of about 2.64×10⁵ gram per molar (g/mol) to about 3.86×10⁵ g/mol, a methoxyl content of about 4.2% to about 4.7% and a galacturonic acid content of about 50.4%.

In some embodiments, the one or more legume sources comprises at least one of chickpea flour, pea flour, lupine flour, soy flour, pigeon pea, pinto beans flour, red lentils flour, lima beans, navy bean, mung bean, black gram flour, yellow pea flour, or a combination thereof. In some embodiments, the chickpea flour comprises (i) proteins comprising albumins and globulins, and (ii) carbohydrates, wherein the proteins and carbohydrates of chickpea flour form matrices with higher water holding capacity, oil binding capacity, emulsion stability and emulsion activity than the starch fractions. In some embodiments, the one or more legume sources present in the plant-only composition ranges from about 10% to about 25% weight by weight of the composition.

In some embodiments, the one or more legume sources present in the plant-only composition ranges from (i) about 1% to about 5% weight by weight of the composition, (ii) about 5% to about 10% weight by weight of the composition, (iii) about 10% to about 15% weight by weight of the composition, (iv) about 10% to about 20% weight by weight of the composition, (v) about 10% to about 25% weight by weight of the composition, (vi) about 15% to about 20% weight by weight of the composition, (vii) about 20% to about 25% weight by weight of the composition, (viii) about 25% to about 30% weight by weight of the composition or (ix) about 30% to about 35% weight by weight of the composition.

In some embodiments, the one or more legume sources has a gelatinization/pasting temperature of about 60° C. to about 80° C., a peak viscosity of about 1107 cP to about 2173 cP, a water holding capacity of about 1.81 grams water per gram (g/g) to about 2.63 g/g, an emulsion stability of about 35% to 90%, a swelling power of about 1.05 g/g to about 21 g/g, a moisture content of about 9.6%, a bulk density of about 410 kilogram per meter cube (Kg/m3) to about 510 Kg/m3, a porosity of about 65% to about 71%, a gelation concentration of about 10% to about 14% and an oil absorbing capacity of about 3 g/g to about 5.74 g/g.

In some embodiments, the food product comprises ice cream, pasta, processed cheese, tomato ketchup, soups, pastry ices, soft viscous candies, fruit-based and membrane-coated items, burgers, burger mixes, sausages, cakes, chocolate bars, pancake mixes, Traditional Burger Products, a baked good, a plant-only burger products, or another food product.

In some embodiments, the plant-only composition comprises (i) about 5% to about 20% weight by weight of one or more plant-derived protein and starch sources, (ii) about 15% to about 25% weight by weight of one or more plant-derived cereal starch, (iii) about 20% to about 30% weight by weight of one or more pectin sources, and (iv) about 10% to about 25% weight by weight of one or more legume sources. The plant-only composition substitutes a gum ingredient in the food product.

In some embodiments, the plant-only composition comprises (i) about 5% to about 20% weight by weight of quinoa flour, (ii) about 15% to about 25% weight by weight of rice starch, (iii) about 20% to about 30% weight by weight of apple pomace, and (iv) about 10% to about 25% weight by weight of chickpea flour. The plant-only composition substitutes a gum ingredient in the food product.

In some embodiments, the plant-only composition present in the food product ranges from about 0.05% to 3% weight by weight of the food product. In some embodiments, the plant-only composition present in the food product ranges from about 0.05% to about 25% weight by weight of the food product depending on the moisture content of the plant-only composition and that of the final food product. In some embodiments, the plant-only composition present in the food product ranges from about 0.1% to about 2% weight by weight of the food product.

In one aspect, a food product is provided. The food product comprises about 10% to about 15% weight by weight a plant-only composition. The plant-only composition comprises (i) about 1% to about 30% weight by weight of one or more plant-derived protein and starch sources, (ii) about 5% to about 35% weight by weight of one or more plant-derived cereal starch, (iii) about 10% to about 40% weight by weight of one or more pectin sources, and (iv) about 1% to about 35% weight by weight of one or more legume sources. The plant-only composition substitutes a gum ingredient in the food product.

In some embodiments, the food product comprises (i) about 10% to about 20% weight by weight of one or more protein sources, (ii) about 5% to about 10% weight by weight of a plant-derived methyl cellulose replacement composition, (iii) about 10% to about 15% weight by weight of one or more plant-derived modified starches, (iv) about 10% to about 12% weight by weight of one or more plant-derived oils, and (v) about 0.5% to about 1% weight by weight of a plant-derived leavener replacement composition.

In some embodiments, the food product comprises (i) about 1% to about 2% weight by weight of one or more plant-derived shelf life extenders, (ii) about 0.5% to about 2% weight by weight of a plant-derived umami flavor, (iii) about 0.5% to about 1% weight by weight of one or more plant-derived flavorants/flavor enhancers, or nutraceuticals, (iv) about 1% to about 2% weight by weight of a second plant-derived flavor enhancer, (v) about 0.5% to about 2% weight by weight of one or more mineral salts, (vi) about 5% to about 10% weight by weight of one or more plant-derived binding agents, (vii) about 1% to about 2% weight by weight of one or more plant-derived leghemoglobin sources, and (viii) about 0.5% to about 2% weight by weight of one or more plant-derived lipid peroxidation inhibitors.

In some embodiments, the one or more protein sources comprises at least one of pea, mushroom, quinoa, chickpeas, or a combination thereof. In some embodiments, the plant-derived methyl cellulose replacement composition comprises at least one of proteins, fiber from whole grains, fruits, seeds, vegetables, starches, vegetable binders, or a combination thereof.

In some embodiments, the one or more plant-derived oils comprises at least one of sunflower oil, coconut oil, flaxseed oil, rice bran oil, other oil comprising at least one of Omega-3 fatty acids, Monounsaturated fatty acids (MUFA), or Medium-chain triglycerides (MCTs), or a combination thereof. In some embodiments, the one or more plant-derived modified starches comprises at least one of tapioca starch, faba bean starch, sorghum starch, quinoa starch, or a combination thereof.

In some embodiments, the plant-derived leavener replacement composition comprises at least one of plant-derived fibers, fruit pectins, fruit acids, plant-derived starches, cereal sources, or a combination thereof. In some embodiments, the plant-derived leavener replacement composition comprises at least one of plum powder, apple cider vinegar, vegan buttermilk, or a combination thereof.

In some embodiments, the one or more plant-derived shelf life extenders comprises at least one of garlic, black pepper, oregano, bay laurel, or a combination thereof. The plant-derived umami flavor comprises at least one of shiake and other mushrooms, tomatoes, garlic, lotus stalk, onions, salt, or a combination thereof. The one or more plant-derived flavorants/flavor enhancers, or nutraceuticals comprises at least one of cumin, coriander, paprika, black pepper, or a combination thereof. The second plant-derived flavor enhancer comprises at least one of nutritional yeast, cashew nuts, or a combination thereof. The one or more mineral salts comprises at least one of Himalayan pink salt, sea salt, or a combination thereof. The one or more plant-derived binding agents comprises at least one of chickpeas, oat fiber, aquafaba, sugar beet pectin, or a combination thereof. The one or more plant-derived leghemoglobin sources comprises at least one of beets, soy, red radish, or a combination thereof. The one or more plant-derived lipid peroxidation inhibitors comprises at least one of black pepper, bay leaf, cumin, or a combination thereof.

In another aspect, a plant-only gum replacement system for a food product comprising a plant-only composition is provided. The plant-only composition comprises (i) about 1% to about 30% weight by weight of one or more plant-derived protein and starch sources, (ii) about 5% to about 35% weight by weight of one or more plant-derived cereal starch, (iii) about 10% to about 40% weight by weight of one or more pectin sources, and (iv) about 1% to about 35% weight by weight of one or more legume sources. The plant-only composition substitutes a gum ingredient in the food product.

The plant-only composition can be used as an alternative/substitute for gum ingredient in the food products, for example, processed cheese, soups, pastry ices, soft viscous candies, fruit-based and membrane-coated items, burgers, burger mixes, cakes, chocolate bars, pancake mixes, traditional burger products, a baked good, a plant-only burger products, or another food product. The plant-only composition replaces conventional gum ingredients in food products that consists of highly processed, plant-derived ingredients while ensuring desirable flavor, texture, appearance and taste as well as the same or similar functionality of conventional gum ingredients for the food product to which the composition is incorporated.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications. Further, one skilled in the relevant art will recognize that the embodiments can be practiced without one or more of the specific details or with other methods, components, materials and so forth. In other instances, well-known structures, materials, or operations are not shown in detail to avoid obscuring the features of the embodiments. Furthermore, the features/aspects described can be practiced in various combinations, though only some of the combinations are described herein for conciseness.

### BRIEF DESCRIPTION OF THE DRAWINGS

The embodiments herein will be better understood from the following detailed description with reference to the drawings, in which.

FIG. 1 illustrates a plant-only composition for a food product according to some embodiments herein; and

FIG. 2 illustrates a flow diagram of a process of preparing a plant-only composition for a food product according to some embodiments herein.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments.

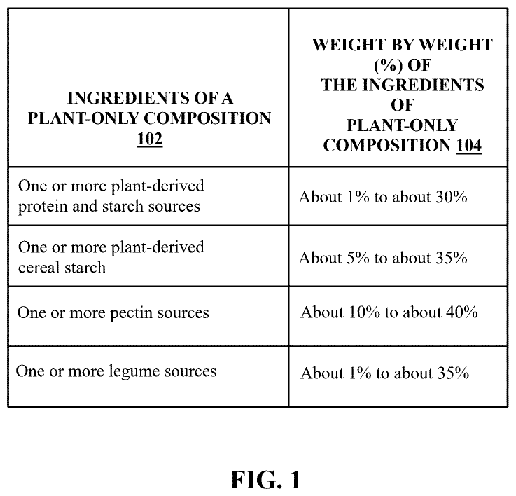

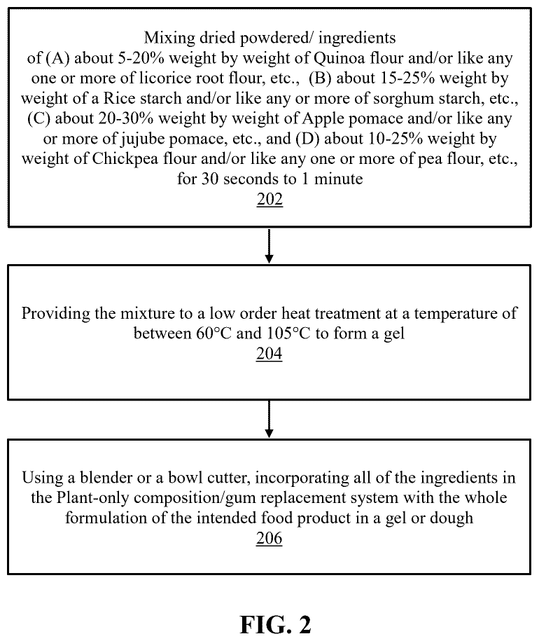

Referring now to the drawings, and more particularly to FIGS. 1 through 2, where similar reference characters denote corresponding features consistently throughout the figures, there are shown preferred embodiments.

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

The terms “comprising”, “comprises” and “comprised of” as used herein are synonymous with “including”, “includes” or “containing”, “contains”, and are inclusive or open-ended and do not exclude additional, non-recited members, elements or method steps.

The Applicant, Live Green Company, is the market maker of the Plant-only category, which means that all the animal, synthetic and ultra-processed ingredients are replaced by plant-derived ingredients with superior nutritional profiles without impacting the original organoleptic properties.

Aspects of the disclosure are provided herein for a plant-only gum replacement system/plant-only composition and components thereof to be used in place of commercially available synthetic or processed gums in a variety of food products. The selection of plant-derived ingredients and combinations of ingredients selected by the Charaka machine learning system provide effective functionalities for gums in food products, including meat substitutes. Commercially available, meat-based and/or imitation meat based food products such as highly processed plant-based, plant-derived, meatless or meat-free burgers, burger mixes and other types of imitation meats and meat-alterative products (together, “Traditional Burger Products”) are one category of food products that can benefit from substitution of commercially utilized gums for plant-derived, non-synthetic ingredients and additives that are minimally processed. In the disclosed embodiments of the gum replacement system, plant-derived ingredients effectively function as texturizing agents, binders, thickeners, stabilizers, emulsifiers and volume enhancers in food products, replacing the conventional, non-plant-derived, synthetic or highly processed additives and ingredients normally found in Traditional Burger Products and other commercially available food products. In the disclosed embodiments, plant-only food additive replacements (or replacement systems) are comprised of only minimally processed, naturally occurring (i.e., non-synthetic) ingredients sourced solely within the plant or fungi kingdoms.

Embodiments disclosed herein include the plant-only gum replacement system (category 2), or components of it, for replacing various gums traditionally found in commercially available food products, including Traditional Burger Products. In some embodiments, the gum replacement system or aspects of the system may replace part of the meat or fibrous material as well as the additives of a (meat-based or plant-derived) Traditional Burger Product. In other embodiments, the gum replacement system or components of it complement the ingredients of plant-based or plant-derived Traditional Burger Products, by providing more plant-only sources that enhance the nutritional or aesthetic value (e.g., flavor) of the food product. In still other embodiments, the gum replacement system's plant-derived ingredients may replace any—even partially—animal-derived ingredients of, so-called “plant-derived,” “plant-based” or meatless, imitation meat food products, including food product mixes. In some embodiments, the gum replacement system may be a standalone, consumable food product. In other embodiments, the replacement system is a food product may be mixed with one or more ingredients or other components of another consumable food product.

The disclosed plant-only gum replacement system (as a food product itself, or for inclusion in other food products) relates to non-synthetic, unprocessed or minimally processed, substitute ingredients for the gums commonly used in commercially available food products. Specifically, the gum substitutes in the replacement system embodiments disclosed herein (category 2) are texturizers, emulsifiers, thickeners, stabilizers and binding agents that, when added to other ingredients to form a consumable food product, alter that a food product's texture and stability. Other gum replacement systems comprise gum substitutes that alter the consistency and reduce cooking loss (category 1); and those that help a food product retain moisture, improving binding and cooking yield (category 3); each of these is the subject of a separate disclosure. The focus of this disclosure is category 2 gum replacements, which may be used or sold, in some embodiments, alone to be added by the purchaser to make a consumable food product or, in other embodiments, to be used in combination with either category 1, or category 3 gum replacement systems, as well as other ingredient replacement systems in the same consumable food product(s). The food systems of the present embodiments are not intended to be consumed as is, but rather, mixed with other ingredients and other plant-only replacement systems to form one or more consumable food products.

“Plant-only” products disclosed herein, as opposed to products labeled as “plant-derived,” “plant-based,” “meatless,” “meat-free” and the like, refer to food products whose ingredients, apart from any significant amount of water added, are derived solely from members of the plant or fungi kingdoms. That is, “plant-only” may refer to any composition, formulation, system, agent, ingredient, or component of a food product, or the entire food product itself, that is produced, developed, or otherwise obtained directly or indirectly from one or more plants or fungi, is not synthetic, and is only minimally processed for production, e.g., cleaned, dried, pulverized, etc.

While some manufacturers may refrain from including any ingredients sourced from animals in their “plant-based” (and other similarly labeled) products, the term “plant-based” may also encompass ingredients and food products that may be obtained from outside the plant or fungi kingdoms. The US Food and Drug Administration currently has no accepted standard definition for labeling of food products described as “plant-based” or “plant-derived,” although a private trade organization, the Plant Based Food Association, has proposed voluntary standards to ensure consistency when the term “plant-based” is used on a product label (i.e., it contains no animal-sourced content), and seeks to certify-through its own certification process-food products, including any food product mixes, that meet this standard. See https://www.plantbasedfoods.org/policy/labeling/. The terminology used on a label for a plant-based food must be truthful under FDA regulations; however, in the US no regulatory body currently requires a company to refrain from including some amount of meat (animal flesh) or other animal-sourced ingredients in a “plant-based” product.

The term “food product” refers broadly to any edible good or product, raw or cooked, savory or sweet, whether intended for human or animal consumption; a food product may be edible although not intended to be consumed on its own but, rather, incorporated into a second (or third) food product that is considered a consumable. The plant-only composition disclosed herein in certain embodiments may be incorporated into or used with meat-based food products; in other embodiments it may be incorporated into or used with seafood-based food products; in still other embodiments, it may be incorporated into or used with plant-based food products. In certain preferred embodiments, the plant-only composition may be incorporated into or used with plant-only food products, including Traditional Burger Products or for providing gum-like functionality in plant-only burger products and other food products.

In certain embodiments, while some of the water content of a food product may be derived from a plant source, water may also be added to the product from an external source. For example, in scenarios in which a plant-only agent or system or plant-only food product is in the form of a gel or liquid, it is further understood that water can be included as solvent or liquid carrier for the plant-only system, ingredient or food product, where any amount of water (some or all) within the system, ingredient or food product may or may not be derived from a plant source. In some embodiments, water may be added from an external source as part of the plant-only gum replacement system (or any other plant-only replacement system referenced herein). In other embodiments, the plant-only gum replacement system may be available in a dried form; in certain embodiments, the dried form may be powdered; in other embodiments, the dried form of the gum replacement system may be in a partially powdered form; in other embodiments, it may be available in a semi-liquid or gel form; in other embodiments, it may be in a liquid or frozen form.

In the disclosed embodiments, apart from externally-sourced water, the plant-derived food product consists entirely of ingredients derived from members of the plant or fungi kingdoms, excluding any component or ingredient that is: (i) dairy-based or otherwise derived from any member of the animal kingdom; and (ii) more than minimally processed; and (ii) synthetic. In some embodiments, the plant-only gum replacement system, or components thereof, replace conventional ingredients and additives found in meat-based food products such as commercially available meat-based burgers. In other embodiments, the gum replacement system replaces those additives found in commercially available plant-based, plant-derived, meatless, meat-free food products that range from burgers and burger mixes to baked goods and frozen food products.

Alternative embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Finally, regardless of whether it is expressly described herein, one of ordinary skill in the art would readily appreciate that each of the particular features, structures, or characteristics of the given embodiments may be utilized in connection or combination with those of any other embodiment discussed herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

Further, the terms “comprising,” “including,” “having,” and the like, as used with respect to embodiments of the present disclosure, are synonymous. As used herein, the terms “agent,” “component,” or “ingredient” are used interchangeably and refer to a particular item that includes one or more chemical compounds (e.g., a food item from one or more plants that comprise one or more naturally occurring chemical compounds).

The term “component” or “ingredient” as used herein, refers to a particular item that includes one or more chemical compounds, e.g., a food item from a member of the plant or fungi kingdoms that comprises one or more naturally occurring chemical compounds. Selection of specific plant-derived ingredients, or specific combinations of plant-only or plant-derived ingredients, provide effective functionalities for gum replacement additives in a food product (e.g., a plant-only food product).

In example embodiments, the plant-only food product includes a combination of components or ingredients from the plant genus that render the combination (in the amounts as indicated) particularly suitable as a gum replacement agent or composition for a food product. In such embodiments, the plant-only gum replacement system is added to other food ingredients to form a final food product formulation that requires such gum replacement composition/system. Examples of food products that utilize gum replacement additives include, without limitation, dessert like products such as Traditional Burger Products or for providing gum-like functionality in plant-only burger products and other food products.

### Charaka Machine Learning (ML) Platform and Ayurvedic System

In general, the selection of a specific combination of ingredients for plant-only products/composition/system is determined using a proprietary machine learning (ML) platform, which blends ancestral wisdoms of plant nutrition with biotechnology and ML to analyze members of the plant and fungi kingdoms and from plants and fungi, the compounds nature offers. The platform utilizes algorithms and includes a database with a significant number of ingredients (e.g., 50,000-100,000 ingredients) and relevant physical properties associated with such ingredients. For example, physical characterization data and information about each ingredient for some or all of the ingredients in the database include, without limitation, functional properties (e.g., emulsification properties, stabilization properties, bulking properties, texturizing properties, gelling properties, fat-replacement properties, etc.). Ayurvedic and/or other holistic properties, physicochemical properties (e.g., pH, viscosity, moisture content, density, etc.), mechanical properties (e.g., adhesive strength, tensile strength, shear resistance, etc.), chemical and/or molecular descriptor properties (e.g., bio-active/bioavailability properties, molecular structure, phytonutrient properties, etc.), sensorial properties (e.g., taste, smell, color, texture, mouth feel, etc.), and nutritional information (e.g., macronutrient/micronutrient properties, etc.) are also considered in the proprietary system to give optimal results in terms of functionality, health and sustainability. Based upon the known properties of ingredients in the database, the desired properties for the food product or formulation, and one or more algorithms associated with the proprietary machine learning platform, a unique combination of plant-derived ingredients is determined to yield an effective gum replacement formulation that can be used to forming a desirable food product or formulation that is effective as a substitute for conventional ingredients in Traditional Burger Products or for providing gum-like functionality in plant-only burger products and other food products.

As noted, the proprietary system identifies natural alternatives, i.e., plant-only alternatives to synthetic, artificial, and animal-derived products, and incorporates, among other things, traditional knowledge known as Ayurvedic medicine. Ayurvedic medicine and its diet principles have been practiced for many thousands of years. This ancient system, among other things, categorizes food by its medicinal properties and desired effects; thus, the proper application of Ayurvedic principles requires knowledge of the self-one's dominant energy, also known as dosha—to prescribe the most advantageous categories of foods from which to choose for an individual's diet. Categories of Ayurvedic properties include but are not limited to Virya (hima/sheeta—cold), Vipaka (Madhura—sweet), Rasa (Madhura—sweet), and Guna (ruksa—dry; or guru—heavy). The information recommended by the proprietary Charaka system permits one to choose between hundreds of alternatives based on ingredients intended to alter a variety of properties to give optimal results for physiological functionality, health, and environmental sustainability.

A food product as described herein that functions to replace gums in Traditional Burger Products or plant-only burger products comprises a combination of solely plant- or fungi-sourced ingredients and added water, if any is required for gum replacement preparation. The plant-only ingredients and combinations of ingredients selected for the gum replacement system are consistent with the requirements and specifications of achieving the functionalities exhibited by conventionally used gums, when used in commercially available food products, including those containing meat substitutes.

### Terms and Definitions

As used in the present invention, the following terms are generally intended to have the meaning as set forth below, except to the extent that the context in which they are used indicate otherwise.

Gums: Gums, or hydrocolloids, are hydrophilic, non-starchy carbohydrate polymers. They are used in food and bakery products as viscosity enhancers and gelling agents and to impart desirable textural and sensory properties.

Protein: Proteins are large biomolecules and macromolecules that comprise one or more long chains of amino acid residues.

Gel: A gel is a semi-solid that can have properties ranging from soft and weak to hard and tough. Gels are defined as a substantially dilute cross-linked system, which exhibits no flow when in the steady-state, although the liquid phase may still diffuse through this system.

Thickener: Thickener refers to a substance which can increase the viscosity of a liquid without substantially changing its other properties.

Emulsifier: Emulsifier is an additive that enables the suspension of one liquid in another.

Emulsion stability: Emulsion stability can be defined as the system's ability to resist changes in its physicochemical properties over time in applications such as food industry.

Foam stability: Foam stability is measured as the time required to lose either 50% of the liquid or 50% of the volume from the foam.

Gelling Agent: Gelling Agent refers to a gel-forming agent (e.g., hydrocolloids) which, when dissolved in a liquid phase as a colloidal mixture, forms a weakly cohesive internal structure.

Swelling Power: Swelling Power refers to water holding capacity of gums, which has generally been used to demonstrate differences between various types of starches.

Gelatinization temperature: Gelatinization temperature is a temperature at which the gelatinization is complete.

Pasting temperature: Pasting temperature is a temperature at which the viscosity begins to increase during the heating process.

Moisture content: Moisture content refers to a quantity of water contained in a material/substance.

Bulk Density: Bulk density is a weight of a volume unit of powder and is usually expressed in g/cm3, kg/m3, or g/100 ml.

Texturizing/Texturing agent: Texturing agent refers to additives that adds or modifies the overall texture or mouthfeel of food products.

Binding agent: Binding agent refers to food binders that are mixed in with other ingredients to help the food product to keep their shape and texture.

Water holding capacity (WHC): Water-holding capacity (or water-binding capacity, or water-absorption capacity) is a measure of the total amount of water that can be absorbed per gram of a powder/composition/ingredient.

Oil Holding Capacity: Oil Holding Capacity (or oil absorbing capacity) is the amount of oil that can be absorbed per unit of weight.

Emulsion activity: Emulsion activity is defined as the maximum amount of oil that can be emulsified by a fixed amount of protein.

Viscosity: Viscosity is the resistance of a fluid (e.g., liquid or gas) to a change in shape or movement of neighbouring portions relative to one another. Viscosity denotes opposition to flow.

Stabilization: Stabilization refers to a process of making composition/food product physically more secure or stable.

pH: pH is a measure of the hydrogen ion concentration in solution and is also referred to as the degree of acidity or alkalinity.

Plant-derived: “Plant-derived” refers to ingredients extracted from a plant.

Flavorant/Flavor enhancer: Flavorant is a food additive that is used to improve the taste or smell of food products.

Nutraceuticals: Nutraceuticals are products derived from food sources that provide both nutrition and medicinal benefits.

Animal-based food products: Animal-based food products refers to food products derived from animals include meat and meat products, poultry products (meat and eggs), fish, shellfish, dairy products (milk and cheese).

Embodiments herein provide a plant-only composition for a food product. The plant-only composition comprises (i) about 1% to about 30% weight by weight of one or more plant-derived protein and starch sources, (ii) about 5% to about 35% weight by weight of one or more plant-derived cereal starch, (iii) about 10% to about 40% weight by weight of one or more pectin sources, and (iv) about 1% to about 35% weight by weight of one or more legume sources. The plant-only composition substitutes a gum ingredient in the food product.

In some embodiments, the plant-only composition comprises (i) about 5% to about 20% weight by weight of one or more plant-derived protein and starch sources, (ii) about 15% to about 25% weight by weight of one or more plant-derived cereal starch, (iii) about 20% to about 30% weight by weight of one or more pectin sources, and (iv) about 10% to about 25% weight by weight of one or more legume sources. The plant-only composition substitutes a gum ingredient in the food product.

In some embodiments, the plant-only composition comprises (i) about 5% to about 20% weight by weight of quinoa flour, (ii) about 15% to about 25% weight by weight of rice starch, (iii) about 20% to about 30% weight by weight of apple pomace, and (iv) about 10% to about 25% weight by weight of chickpea flour. The plant-only composition substitutes a gum ingredient in the food product.

In one aspect, a food product is provided. The food product comprises about 10% to about 15% weight by weight a plant-only composition. The plant-only composition comprises (i) about 1% to about 30% weight by weight of one or more plant-derived protein and starch sources, (ii) about 5% to about 35% weight by weight of one or more plant-derived cereal starch, (iii) about 10% to about 40% weight by weight of one or more pectin sources, and (iv) about 1% to about 35% weight by weight of one or more legume sources. The plant-only composition substitutes a gum ingredient in the food product.

In another aspect, a plant-only gum replacement system for a food product comprising a plant-only composition is provided. The plant-only composition comprises (i) about 1% to about 30% weight by weight of one or more plant-derived protein and starch sources, (ii) about 5% to about 35% weight by weight of one or more plant-derived cereal starch, (iii) about 10% to about 40% weight by weight of one or more pectin sources, and (iv) about 1% to about 35% weight by weight of one or more legume sources. The plant-only composition substitutes a gum ingredient in the food product.

### Plant-Only Gum Replacement System for Food Products

FIG. 1 illustrates a plant-only composition for a food product according to some embodiments herein. FIG. 1 depicts a table that includes ingredients 102 of the plant-only composition and weight 104 of the ingredients 102 of the plant-only composition. The plant-only composition comprises (i) about 1% to about 30% weight by weight of one or more plant-derived protein and starch sources, (ii) about 5% to about 35% weight by weight of one or more plant-derived cereal starch, (iii) about 10% to about 40% weight by weight of one or more pectin sources, and (iv) about 1% to about 35% weight by weight of one or more legume sources. The plant-only composition substitutes a gum ingredient in the food product. Table 1 shows the each of the preferred, essential plant-derived ingredients in the (category 2) gum replacement system, whose functionalities include texturizing, thickening, binding, emulsifying and stabilizing the food products in which these replacement ingredients are added.

TABLE 1
The ingredients and the functionalities of the
plant-only composition/gum replacement system:

| Categories | Ingredients |
|---|---|
| Plant derived protein and | Quinoa flour, Licorice root flour, almond flour, |
| starch source | bamboo seeds flour, Jackfruit seed flour, oats flour, |
| | Arrowroot powder, Yam flour, mung bean flour, soy |
| | flour |
| Plant derived cereal starch | Rice starch, sorghum starch, maize starch, wheat |
| | starch, barley starch, pearl millet starch, ragi flour, |
| | finger millet starch, oats starch, rye starch |
| Pectin source | Apple pomace (pectin), Jujube pomace, Redcurrant |
| | pectin, blackberry pectin, strawberry pectin, orange |
| | pomace, dragon fruit peel pectin, raspberry pectin |
| Legume source | Chickpea flour (starch, protein), Pea flour, lupine |
| | flour, Soy flour, pigeon pea, pinto beans flour, red |
| | lentils flour, lima beans, navy bean, mung bean, |
| | black gram flour, yellow Pea flour |

In some embodiments, the plant-only composition comprises (i) about 5% to about 20% weight by weight of quinoa flour, (ii) about 15% to about 25% weight by weight of rice starch, (iii) about 20% to about 30% weight by weight of apple pomace, and (iv) about 10% to about 25% weight by weight of chickpea flour. The plant-only composition substitutes a gum ingredient in the food product.

Gums used as additives in commercially available food products generally texturize, thicken, bind, emulsify, stabilize and may also help retain moisture and improve cooking yields. Other types of highly processed or synthetic additives such as phosphates, maltodextrin and others have similar functionalities in food products and, as a result, the gum replacement system embodiments disclosed may replace those types of additives as well. Table 2 shows the percent by weight of each of the preferred, essential plant-only ingredients in the (category 2) gum replacement system, whose functionalities include texturizing, thickening, binding, emulsifying and stabilizing the food products in which these replacement ingredients are added.

TABLE 2
The plant-only composition/gum replacement system

| Plant-Only Composition/Gum | Preferred Weight by Weight |
|---|---|
| Replacement System (Category | Percent (%) of the Plant-Only |
| 2) Preferred, Essential | Composition/Gum Replacement |
| Ingredients | System |
| Quinoa flour (starch, protein) | 5-20 |
| Rice starch | 15-25 |
| Apple pomace (pectin) | 20-30 |
| Chickpea flour (starch, protein) | 10-25 |

From the Table 2, within this category 2, set of gum replacement ingredients, one ingredient (or an alternative plant-derived ingredient exhibiting the same or similar functionalities and properties) may be used as the plant-only composition/gum replacement system. In other embodiments, two or more may be combined in varying amounts for the plant-only composition/gum replacement system. In some embodiments, all four of the preferred essential ingredients listed in Table 2 may be used as the plant-only composition/gum replacement system. In alternative embodiments, any of the ingredients listed may be replaced with one or more substitute ingredients that impart the same or similar properties and functionalities as each of the ingredients listed

Further, although Table 2 provides a preferred, essential list of categories of ingredients with certain properties in the plant-only composition/gum replacement system, substitutions for these ingredients in the plant-only composition/gum replacement system may be made in alternative embodiments for compliance with dietary requirements; without limitation, such as food sensitivities and food allergies.

The plant-only composition/gum replacement system detailed in Table 2 as a component of a plant-only burger product or a Traditional Burger Product comprises generally between about 0.05 to about 3 percent dry weight of the total weight of the food product, but may vary between as much as 0.05 percent to about 25 percent or more of the total weight, depending on the moisture content of the plant-only composition/gum replacement system and that of the final food product (e.g., whether a plant-only burger product (Table 3) or a Traditional burger Product (Tables 5 and 6), whether a dry mix or other form).

TABLE 3
Various plant-only composition/gum replacement systems' ingredients
and combinations as components of plant-only burger products

| | Preferred Dry |
|---|---|
| | Weight by Weight |
| Preferred, Essential, Plant-Only Food Product | Percent (%) of |
| Replacement Systems and/or Individual Ingredients | Plant-Only |
| and Combinations | Burger Product |
| Protein sources (one or more of pea, mushroom, quinoa, | 10-20 |
| chickpeas) | |
| Methyl Cellulose (MC) replacement system ingredients | 5-10 |
| from all five categories (proteins; fibers from whole grains, | |
| fruits, seeds and vegetables; starches; and vegetable binders) | |
| within the ranges indicated for the plant-only | |
| composition/gum replacement system | |
| Modified Starches replacement system comprising four | 10-15 |
| starch source categories, including, among other ingredients, | |
| tapioca starch, faba bean starch, sorghum starch, quinoa | |
| starch and/or substitute(s) exhibiting similar or the same | |
| properties and functionalities) | |
| Oils providing high levels of omega-3 fatty acids, MUFAs, | 10-12 |
| & MCTs (e.g., sunflower oil, coconut oil, flaxseed oil, rice | |
| bran oil, or other oil providing such fats at desired levels) | |
| Gum replacement system(s), any one or more of categories | 10-15 |
| 1-3, depending on the desired characteristics of the plant- | |
| only food product (i.e., category 2 gums - one or more of | |
| four preferred, essential ingredients: chickpea protein and | |
| starch, rice starch, quinoa starch, and apple pomace | |
| (pectin), as well as and/or one or more substitute(s) for any | |
| of these ingredients exhibiting similar or the same | |
| properties and functionalities | |
| Shelf life extenders (one or more of garlic, black pepper, | 1-2 |
| oregano, bay laurel) | |
| Umami flavor (one or more of shitake and other | 0.5-2 |
| mushrooms, tomatoes, garlic, lotus stalk, onions, salt) | |
| Flavorant, flavor enhancer, nutraceutical (one or more of | 0.5-1 |
| cumin, coriander, paprika, black pepper) | |
| Flavor Enhancer (one or more of nutritional yeast, cashews) | 1-2 |
| Mineral Salts (Himalayan pink salt, sea salt, etc.) | 0.5-2 |
| Binding agents (one or more of chickpeas, oat fiber, | 5-10 |
| aquafaba, sugar beet pectin) | |
| Leavener replacement system ingredients from five | 0.5-1 |
| categories (plant-only fibers; fruit pectins; fruit acids; plant- | |
| only starches; and cereal sources) | |
| Leghemoglobin source(s) (one or more of beets, soy, red | 1-2 |
| radish) | |
| Lipid peroxidation inhibitors (one or more of black pepper, | 0.5-2 |
| bay leaf, cumin) | |

The plant-only composition/gum replacement system may comprise, as a percent by weight of the food product in which it is added, depending on the type of food product and whether water or other liquid is included as part of the food product, included but not limited to Traditional Burger Products and plant-only burger products, between about 0.05 to about 25 percent or more, between about 0.05 and about 3 percent, between about 0.05 and 5 percent, between about 0.1 to about 0.5 percent, between about 0.1 to about 2 percent, between about 0.1 to about 5 percent, between about 0.2 to about 0.4 percent, between about 0.4 to about 0.6 percent between about 0.6 to about 0.8 percent, between about 0.8 to about 1 percent, between about 1 to about 1.2 percent, between about 1.2 to about 1.4 percent, between about 1.4 to about 1.6 percent, between about 1.6 to about 1.8 percent, between about 1.8 to about 2.0 percent, between about 2.0 to about 2.5 percent, between about 2 to about 3 percent, between about 3 to about 5 percent, between about 5 to about 10 percent, between about 10 to about 15 percent, between about 15 to about 20 percent, and between about 20 to about 25 percent.

Preferred, Essential Ingredients and their Interactions in the Plant-Only Composition/Gum Replacement System (Category 2)

The preferred, essential ingredients listed in Table 2 are identified by the Charaka machine learning system referenced above. One or more plant-only, minimally processed and non-synthetic alternative ingredients may also be used in the plant-only composition/gum replacement system (or may replace one or more of the listed ingredients). Such alternatives may be known to a person of ordinary skill to exhibit the same or similar functionalities and properties as one or more of the preferred, essential ingredients in the category 2 plant-only composition/gum replacement system.

Quinoa flour contains protein and starch. Quinoa starch is relatively low (11%) in amylose content with small (1-3 μm) granules. It exhibits low pasting temperature and high freeze-thaw stability; it is frequently used as a thickener. The protein in quinoa flour helps provide structure to food products. In addition, quinoa contains saponins, compounds that may offer some health benefits such as antioxidant activity. Quinoa starch promotes the ayurvedic properties of Rasa: Madhura (sweet); Guna: Laghu (light); Vipaka: Madhura (sweet); Virya: Sheeta (cold).

In the disclosed embodiments, quinoa flour and/or a substitute with the same or similar properties and functionalities as these ingredients as a percent of the plant-only composition/gum replacement system weight, ranges from between about 1 to about 30 percent, between about 1 to about 5 percent, between about 5 and about 10 percent, between about 5 to about 20 percent, between about 10 to about 20 percent, between about 15 to about 20 percent, between about 20 to about 25 percent, and between about 25 to about 30 percent.

Rice starch contains amylose and amylopectin units in a 20:80 ratio. Particle sizes of the rice starch is ranged from 1 to 100 μm. Rice starch also exhibits various properties such as swelling power, water solubility, water absorption capacity and pasting properties. In some embodiments, rice starch is provided in the category 2 plant-only composition/gum replacement system as a finely ground powder. In other embodiments, they may be mixed with water, plant-derived liquid or other liquid to form a liquid, gel or other alternative form the system suitable for mixing and storing, freezing and/or drying. Rice starch promotes the ayurvedic properties of Rasa: Madhura (sweet); Kashaya (astringent); Guna: Laghu (light); Snighdha (slimy); Virya: Sheeta (cold); Vipaka: Madhura (sweet). The ayurvedic properties of the plant-derived ingredients are shown in Table 8.

In the disclosed embodiments, rice starch and/or a substitute with the same or similar properties and functionalities as these ingredients as a percent of the plant-only composition/gum replacement system weight, ranges from between about 5 to about 35 percent, between about 5 to about 10 percent, between about 10 to about 15 percent, between 15 to about 20 percent, between 15 to about 25 percent, between about 20 to about 25 percent, between about 25 to about 30 percent, and between about 30 to about 35 percent.

Apple pomace (pectin) is a low methyl cellulose pectin, forming a thermo-irreversible gel, indicating it will remain gelled even when heated to temperatures that would normally melt it. This pectin contributes to small droplet size emulsions, showing higher stability and formed gel-like matrices. Insoluble fibers maintain emulsion stability through the pickering mechanism and network formation in the continuous phase, likely favored by stabilization of proteins and pectins in the soluble fraction. In some embodiments, apple pomace (pectin) is provided in the category 2 plant-only composition/gum replacement system as a finely ground powder. In other embodiments, they may be mixed with water, plant-derived liquid or other liquid to form a liquid, gel or other alternative form the system suitable for mixing and storing, freezing and/or drying. Apple pomace (pectins) promotes the ayurvedic properties of Rasa: Madhura (Sweet); Guna: Guru (Heavy to digest); Virya: Hima (Cold); Vipaka: Madhura (Sweet).

In the disclosed embodiments, apple pomace and/or a substitute with the same or similar properties and functionalities as these ingredients as a percent of the plant-only composition/gum replacement system weight, ranges from between 10 to about 40 percent, between about 10 to about 15 percent, between about 15 to about 20 percent, between about 20 to about 25 percent, between about 25 to about 30 percent, between about 20 to about 30 percent, between about 30 to about 35 percent, and between about 35 to about 40 percent.

Chickpeas, commonly known as garbanzo beans, are an old world pulse (i.e., edible seeds) in the legume family. The main proteins found in chickpeas, similar to other legumes, are albumins and globulins. The protein isolates and starches form matrices with higher water holding capacity, oil binding capacity, emulsion stability and emulsion activity than the starch fractions. The legume is a rich source of protein and carbohydrates, including starches, making it an excellent replacement for meat vegetarian and vegan dishes. Chickpeas are provided in the system as a finely ground powder (flour and/or separate starch and proteins). Chickpeas promote the ayurvedic properties of Rasa: Madhura (Sweet), Kasaya (Astringent), Guna: Laghu (light) Ruksha (dry) and Viraya: Hima (Cold), as shown in Table 4.

In the disclosed embodiments, the amount of chickpea flour, including starch and protein components as a percent of the plant-only composition/gum replacement system weight ranges from between about 1 to about 35 percent, between about 1 to about 5 percent, between about 5 to about 10 percent, between about 10 to about 15 percent, between about 10 to about 20 percent, between about 10 to about 25 percent, between about 15 and about 20 percent, between about 20 to about 25 percent, between about 25 to about 30 percent, and between about 30 to about 35 percent.

The final texture of the food product in which these ingredients are used will be thicker and stiffer due to the binding of water soluble starches by the starches, pectin and proteins. The presence of globulins and albumins (proteins) exhibit excellent water and oil binding capacity. The presence of hydrocolloids and starches may reduce adhesiveness as the ingredients form a stable network structure that entraps starch granules, slowing down the amylose release during cooking. Hydrocolloids and starches also form a strong protein network, increasing the cohesiveness of the food product. The hydrophilic component in the hydrocolloids interacts ionically with the proteins in the food product to improve its structure in, e.g., a Traditional Burger Product or plant-only burger product.

Apple pomace (pectin) is a low methoxyl pectin combined with starch molecules, and reduces the viscosity of the system and the food products in which it is a component. Quinoa starch and rice starch have similar amylograph properties that show higher viscosity and similar water binding capacities. Chickpea starch, apple pomace, and quince seed mucilage together will result in reduced cooking loss. In addition, apple pomace exhibits high water binding capacity providing a degree of control and enabling in the desirable rheology and textural properties of the burger or other food product. Chickpea protein, pectin, rice starch and quinoa flour together function as binders and thickening agents. Polysaccharides and proteins interact with each other via electrostatic interaction, hydrogen bonding or van der waals forces depending on physical factors such as pH and temperature. The presence of moisture in plant-based meat, the viscosity and the rheology of the system is affected.

Surface active proteins can play a role in the formation and stabilization of emulsions in the presence of polysaccharides, while interacting through electrostatic or hydrophobic—hydrophobic interactions. Polysaccharides and proteins both contribute to the textural and structural properties by changing the rheology through their gelling networking system, water retention properties. With this basis, the desired properties can be attained for combining chickpea proteins and pectin. Apple pomace (pectin) and chickpea proteins combine together and form soluble complexes that aid efficient protein solubility and thermal stability. Both have better water retention properties that aid in binding action apart from the emulsification and stabilization provided to the burger components.

Pectins and proteins interact to increase viscosity of the consumable food product such as a plant-only burger product. The optimum combination of proteins and pectin and starch, increased hardness, gumminess, chewiness and optimum cohesiveness can be achieved. Further, proteins and pectins interact to form complexes that can bind water and fat together, which can contribute to maintaining food yield (and reducing shrinkage) during cooking. Increased protein level from quinoa and chickpea flours also reduce the adhesiveness. Pectin and starches in the plant-only composition/gum replacement system provide structure to the food product. The addition of apple pomace (pectin) also may improve storage life of consumable food products.

Chickpeas and other legumes, when mixed with quinoa starch develop a strong protein-starch network with other ingredients, promoting structural stability and integrity in the consumable food product. Although, quinoa is a low-fat protein source, it has a higher fat content than wheat and other grasses. It contains oleic and alpha-linolenic acids, both heart-healthy, monounsaturated fats that contribute to reduced cooking loss and discoloration of the consumable food product. Hydrocolloids in the plant-only composition/gum replacement system ingredients form a strong network and interact with other components in food products. In either Traditional Burger Products or plant-only burger products, plant-only composition/the gum replacement system ingredients, and/or substitutes exhibiting the same or similar functionalities and properties, promote structural stability and integrity of the food product.

The gums categories 1, 2 and 3 may be used in any combination as components of one or more food products depending on the desired effects, including non-starch-versus starch-related hydrocolloid interactions. In some embodiments, when certain ingredients of the gum replacement systems are used together in a food product, they provide synergistic, enhanced or varied functionalities and properties in combination that any one gum replacement system may not offer.

The single ingredient of the plant-only composition/gum replacement system and their various combinations along with their Ayurvedic properties (as shown in Table 4) results in a plant-only (category 2) composition/gum replacement system that may be use in whole or part in any variety of food products, the primary example of the disclosed embodiments for Traditional Burger Products and other, plant-only burger products. Alone or in combination as a gum replacement system, the previously described ingredient categories are effective and natural components in the plant-only composition/gum replacement system for burger products, baked products or other food product categories in an amount of about 0.05 percent to up to 25 percent or more by weight of the food product, depending on the type of food product and the replacement ingredients needed or desired, as indicated above in the paragraph following Table 3. Table 3 above shows preferred weight range percentages within a plant-only burger product for the plant-only composition/gum replacement system(s) (between about 10-15% dry weight of the burger product), as well as for other replacement systems and categories of other replacement ingredient combinations. The plant-only composition/gum replacement system may be incorporated in much lower amounts in other food products. In some embodiments, Traditional Burger Products including so-called plant-based burger products may have a much lower quantity of gum replacement system ingredients, e.g., in some embodiments, within a range between about 0.1 to about 2 percent of the weight of the food product.

### Preparation of the Plant-Only Composition/Gum Replacement System and Individual Ingredients

In one embodiment, the plant-only composition/gum replacement system, individual ingredients or combinations of ingredients can be prepared by combining and mixing the dried, powdered ingredients selected from Table 2 in the relative amounts identified as preferred, essential ingredients of the system to be used in a desired food product. In some embodiments, the plant-only composition/gum replacement system may be in the form of a liquid or gel due to the addition of water or other plant-derived liquid to one or more of the ingredients or categories of ingredients before mixing, such as, for example, aquafaba in liquid form. In some embodiments, the plant-only composition/gum replacement system is mixed with additional water or plant-derived liquid, then dried and powdered and stored. In some embodiments, the plant-only composition/gum replacement system is prepared in liquid form and freeze dried. In certain embodiments, the plant-only composition/gum replacement system may be prepared and stored as a liquid or moist form (as in a gel or dough). In certain other embodiments, the plant-only composition/gum replacement system may be prepared as a liquid, gel or in dried form and then frozen for storage. In other embodiments, each of the categories of ingredients, individual ingredients, or combinations of ingredients within each of the categories of the plant-only composition/gum replacement system, whether in liquid, gel, dried or other form, are mixed individually directly into and become a part of another food product rather than being combined as the complete replacement system prior to incorporation into another food product.

In some embodiments, the plant-only composition/gum replacement system stands alone as a plant-only food product that can be added to one or more ingredients or other food replacement systems to form any type of consumable food product requiring one or more plant-only composition/gum replacement systems. In other embodiments, the plant-only composition/gum replacement system is a component of a plant-only burger product, or other imitation meat product. In certain embodiments, the plant-only composition/gum replacement system is a component of a baked good food product, or a frozen burger or burger mix, which may then be incorporated into other food products. In still other embodiments, the food product is one of several components used to create final food product. In other embodiments, the food product is a Traditional Burger Product. In some embodiments, the ingredients of Table 2 may be selected and combined in other relative amounts (a variety of ranges) identified for each of the four plant-only composition/gum replacement system ingredients discussed infra to achieve the required functional characteristics most closely resembling those of conventionally used gums in a variety of food products, including, e.g., Traditional Burger Products.

The combination of categories and ingredients comprising a plant-only composition/gum replacement system for traditional ingredients and additives in commercially available animal-based and plant-based products, as well as their physicochemical and Ayurvedic properties are shown in Table 4.

TABLE 4
Plant-only composition/gum replacement system's
(Category 2) ingredients and their properties

| | Compounds responsible | Physicochemical | Ayurvedic |
|---|---|---|---|
| Ingredient | for functionality | properties | properties |
| Apple | Pectins help form small | Emulsion stability: | Rasa: |
| pomace | droplet size emulsions, | 35% to 80% or more | Madhura |
| (pectin) | showing higher stability | Oil Holding Capacity: | (Sweet); |
| | and formed gel-like | 2.97-11 g of oil/g of | Guna: Guru |
| | matrices. Insoluble fibers | sample | (Heavy to |
| | maintain emulsion | Water holding capacity: | digest); |
| | stability through the | 3-17 g/g or more | Virya: Hima |
| | pickering mechanism | pH: ~3.9 | (Cold); |
| | and network formation in | Molecular weight: | Vipaka: |
| | the continuous phase, | 2.64 × 10⁵ g/mol with | Madhura |
| | likely favored by | extraction from microwave | (Sweet) |
| | stabilization of proteins | assisted (MAE) | |
| | and pectins in the soluble | 3.86 × 10⁵ g/mol with | |
| | fraction. | extraction from ultrasound | |
| | | assisted (UAE) | |
| | | Methoxyl content: 4.2 to | |
| | | 4.7% | |
| | | Apple pomace (pectin) is a | |
| | | low methyl cellulose | |
| | | pectin, forming a thermo- | |
| | | irreversible gel, indicating | |
| | | that it will remain gelled | |
| | | even when heated to | |
| | | temperatures that would | |
| | | normally melt it. | |
| | | Galacturonic acid | |
| | | content: 50.4% | |
| Chickpea | Chickpeas provide | Gelatinization/Pasting | Rasa: |
| flour | significant amounts of | Temperature: | Madhura |
| | carbohydrates and | 60° C. to 80° C. | (sweet); |
| | protein. The | Peak viscosity (cP): | kasaya |
| | carbohydrates primarily | 1107-2173 cP | (astringent); |
| | are in the form of | Water holding capacity | Guna: |
| | starch (93-98%). | (WHC): | Laghu |
| | Protein isolates (72-85% | 1.81-2.63 g water/g | (light); |
| | of proteins) include | Emulsion stability: | Ruksha |
| | mainly globulins and | 35-90% or more | (dry); |
| | albumin, which form | Swelling power: | Virya: |
| | matrices that bind and | 1.05 to 21 g/g | Hima (cold) |
| | retain water. | (range is temperature | |
| | | dependent, upper limit is | |
| | | taken at 100° C.) | |
| | | Moisture: 9.6% | |
| | | Bulk Density: | |
| | | 410-510 Kg/m3 | |
| | | Porosity: 65-71% | |
| | | Final Viscosity: 1515- | |
| | | 2704 mPa · s | |
| | | Chick pea protein | |
| | | isolates' least gelation | |
| | | concentration: 10-14% | |
| | | Oil absorbing capacity: | |
| | | 3-5.74 g/g | |
| Rice | Rice starch contains | Gelatinization/Pasting | Rasa: |
| Starch | amylose and amylopectin | Temperature: | Madhura |
| | units in a 20:80 ratio. | 68° C.-72° C. | (sweet); |
| | | Peak viscosity: | Kashaya |
| | | 1296-3348 cP or more | (astringent); |
| | | WHC: | Guna: Laghu |
| | | 2.42-3.35 g/g | (light); |
| | | Amylose content: | Snighdha |
| | | 14-30% | (slimy); |
| | | Swelling power: | Virya: |
| | | 3.3 to 8.8 g/g | Sheeta |
| | | Molecular weight: | (cold); |
| | | 5.4 × 10⁷ | Vipaka: |
| | | Particle size distribution: | Madhura |
| | | Particle sizes ranged from | (sweet) |
| | | 1 to 100 μm. | |
| | | Rice starch also exhibits | |
| | | various properties such as | |
| | | swelling power, water | |
| | | solubility, water absorption | |
| | | capacity and pasting | |
| | | properties. | |
| Quinoa | Quinoa starch is | Gelatinization/Pasting | Rasa: |
| Starch | relatively low in | Temperature: | Madhura |
| And | amylose content (e.g., | 68.6-69.3° C. | (sweet); |
| Protein | 11%), and has very | Peak viscosity: | Guna: |
| | small granules (1-3 μm). | 0.1 and 0.9 Pa · s, | Laghu |
| | It exhibits low pasting | at a shear | (light); |
| | temperature and | rate of 115 s−1 | Vipaka: |
| | high freeze-thaw | WHC: | Madhura |
| | stability, and can be used | 415.13-595.26% | (sweet); |
| | as a thickener. | Emulsion stability: | Virya: |
| | The protein in quinoa | 35-90% or more | Sheeta |
| | flour helps provide | Swelling power: | (cold) |
| | structure to food | 20.76-26.92% | |
| | products. | Moisture: 12.6% | |
| | Quinoa contains | Tapped bulk density: | |
| | saponins, which are | 0.72 g/mL | |
| | bitter | Emulsion capacity: 100% | |
| | compounds that may | Foaming capacity: 17% | |
| | offer some health | Water soluble index: | |
| | benefits such as | 11.5-13% | |
| | antioxidant activity. | | |

Table 5 below provides an overview of the typical formulation of a commercially available, meat-based burger, including preservatives and other chemical additives.

TABLE 5
Typical formulation for commercially available meat-based burgers.

| | Weight by | |
|---|---|---|
| Meat-based | weight percent | |
| Ingredient/category | (%) of burger | Function |
| Beef/Pork | up to 60-70 | Meat-based protein and fat source |
| Water | up to 10 | Moisture |
| Beef Fat | up to 15-20 | Animal fat source |
| Soy Protein | up to 10-15 | Protein source |
| Salt | up to 10-15 | Flavor |
| Caramel color | 5-15 | Colorant |
| Sodium polyphosphates | 2-4 | Stabilizer, meat curer |
| Maltodextrin | 0.25-0.75 | Fat replacer, shelf life extender |
| Cochineal carmine | 5-15 | Colorant |
| Monosodium glutamate | 0.1-0.8 | Flavoring agent |
| Onion | 5-10 | Preservative, flavor enhancer |
| Garlic | 5-10 | Preservative, flavor enhancer |
| Cumin | 1-5 | Preservative, flavor enhancer |
| Sodium erythorbate | 0.5-0.7 | Cure accelerator |
| Natural beef/pork flavors | 1-2 | Flavor |
| Sodium citrate | 2-3 | Acidity regulator |
| Disodium inosinate | 0.1-0.3 | Flavor enhancer |
| Sodium guanylate | 0.1-0.3 | Flavor enhancer |
| Black pepper | 1-5 | Flavor enhancer |
| Capsicum | 1-5 | Flavor enhancer |
| Soybean | 10-40 | Textured vegetable protein |
| Nisin | 0.01-0.05 | Preservative |
| Nitrites and Nitrates | 1-5 | Taste, colorant, antimicrobial |
| Phosphate Salts | 0.1-0.5 | Moisture retention, stabilizer, |
| | | shrinkage reducer, flavor enhancer, |
| | | colorant |
| Tertiary | 0.02-0.03 | Antioxidant |
| butylhydroquinone | | |
| (TBHQ) | | |

In some embodiments, the plant-only composition/gum replacement system when added to plant-based products within the Traditional Burger Products such as in the example above, replaces any gums, maltodextrin and a small percent of soybean, in an amount between about 0.1 and about 2 percent of the weight, or up to about 5 percent of the plant-based burger product, as in Table 5 below.

Table 6 below, similarly provides an overview of the typical formulation of a commercially available, plant-based burger or burger mix, with numerous chemical additives. Although a somewhat improved profile compared to the profile of the formulation of the meat-based burger shown in Table 5, it can be improved for certain consumer diets with the use of plant-only replacements such as the plant-only composition/gum replacement system. The plant-only composition/gum replacement system may also be used to improve the quality of meat-based food products intended for pets and other animals.

TABLE 6
Typical formulation for commercially available, plant-based burgers

| | Weight by | |
|---|---|---|
| Plant-based Burger | weight Percent | |
| Ingredient/Category | (%) of Product | Function |
| Pea protein isolate | 70-80 | Protein source |
| Water | Variable | Moisture |
| Expeller-pressed canola | 2-5 | Fat source |
| oil | | |
| Refined coconut oil | 20-25 | Fat source |
| Cellulose from bamboo | ≤2 | Texturizer |
| Methylcellulose | 0.1-2 | Thickener, emulsifier, and binder |
| Potato starch | 2-4 | Thickener |
| Flavoring agents | 10-15 | Flavor |
| Maltodextrin | 0.2-0.9 | Fat replacer, shelf-life extender |
| Yeast extract | 1-2 | Flavor enhancer |
| Salt | 2-5 | Flavor |
| Sunflower oil | 8-10 | Fat source |
| Vegetable glycerin | 5-15 | Sweetener |
| Dried yeast | 1-3 | Flavoring agent |
| Gum arabic, konjac gum, | 0.1-2 | Emulsifier, binder, stabilizer, |
| xanthan gum, Locust bean | | thickener, foaming agent, texturizer, |
| gum, carrageenan | | moisture retention. |
| Citrus extract (to protect | 1-3 | Antimicrobial, preservative |
| quality) | | |
| Ascorbic acid (to maintain | 0.1-1 | Color retention |
| color) | | |
| Beet juice extract (for | 5-10 | Colorant |
| color) | | |
| Acetic acid | 0.5-2 | Shelf-life extender |
| Succinic acid | 1-2 | Acidulant/flavoring agent |
| Modified food starch | 5-15 | Texturizer |
| Annatto (for color) | 2-5 | Colorant |

In some embodiments, the plant-only composition/gum replacement system when added to plant-based burger products such as in the example above, replaces some or all of the gums used in commercially available plant-based burger products: gum arabic, konjac gum, xanthan gum, locust bean gum, carrageenan at the same levels, e.g., as shown above, in a dry weight range of approximately 0.1 to 1 percent, and up to 5 percent or more.

Table 7 below provides a comparison of the commercial plant-based versus currently disclosed, plant-only composition/formulations burger products with a variety of replacement systems.

TABLE 7
Comparison of formulations of plant-based burgers and burger mixes versus
commercially available plant-only burgers and burger mixes, indicating
relevant replacements for traditional additives in plant-based burger

| Example Formulation of | |
|---|---|
| Commercially Available | |
| Plant-based Burger | |
| Products with Traditional | |
| Additives, | Plant-only Composition/Formulation for Burger |
| Including Gums | Products Replacing Commercially Available Gums |
| Pea protein isolate | One or more protein source(s) (peas, lupine, |
| | mushrooms, quinoa, chickpea, etc.) |
| Water | Water (from plant or external source) |
| Expeller-pressed canola oil | One or more oils (sunflower, coconut, flaxseed and rice |
| Refined coconut oil | bran) comprising high levels of MUFAs, omega-3 fatty |
| Sunflower oil | acids, & MCTs |
| Cellulose from bamboo | Plant-derived methyl cellulose (MC) replacement |
| Methylcellulose | system (blend of five categories of ingredients: |
| | protein, fibers from whole grains; fibers from fruits, |
| | seeds and vegetables, vegetable binding agents and |
| | starches (0.5-30% weight of the plant-derived burger |
| | product, depending on whether water or other liquid is |
| | included in the burger product or other mix). |
| Annatto (for color) | Plant-derived color and flavorants, nutraceuticals |
| Natural flavor | (one or more of cumin, coriander, paprika, black pepper, |
| | etc.) |
| | Plant-derived umami flavor replacement system (one or |
| | more of shiitake and other mushrooms, tomatoes, garlic, |
| | lotus stalk, onions, mineral salts, etc.) |
| Maltodextrin | Plant-derived shelf-life extender |
| | (one or more of garlic, black pepper, oregano, bay leaf |
| | etc.) |
| Yeast extract | Flavor enhancer (one or more of nutritional yeast, |
| Vegetable glycerin | cashews etc.) |
| Dried Yeast | Plant-derived leavener replacement system |
| | (combination of ingredients from five categories, |
| | including one or more of psyllium husk, apple pomace, |
| | rice starch, faba beans, plum powder, etc.) |
| Salt | Mineral Salts (Himalayan pink salt, sea salt) |
| Gum arabic, konjac gum, | Plant-derived gum replacement system (category 2 |
| xanthan gum, locust bean | gums - one or more of four preferred, essential |
| gum, carrageenan | ingredients: chickpea protein and starch, rice starch, |
| | quinoa starch, and apple pomace (pectin)) |
| Citrus extract (to protect | Plant-derived leghemoglobin (one or more of beets, red |
| quality) | radish, etc.) |
| Ascorbic acid (to maintain | |
| color) | |
| Beet juice extract (for | |
| color) | |
| Acetic acid | Plant-derived shelf life extender (one or more of garlic, |
| | black pepper, onion etc.) |
| Succinic acid | Plant-derived flavor enhancer (one or more of paprika, |
| | black pepper, beet juice, etc.) |
| Modified food starch | Plant-derived modified starches replacement (one or |
| Potato starch | more of tapioca, faba bean, sorghum, quinoa, etc.) |

Table 8 below provides a detailed description of the functionality of the various plant-only composition/gum replacement systems and other categories of ingredients specific to plant-only burger products, as determined by the Charaka machine learning system described above.

### Functionality of Plant-Only Composition/Gum Replacement Systems for Burger Products

The unique combination of essential ingredients in each plant-only composition/gum replacement systems, including individual ingredients or combinations of ingredients within each category of the system provides certain functionalities necessary for quality, plant-only burger products, as shown in the following table 8.

TABLE 8
Functionalities Provided by Plant-Only Composition/Gum
Replacement Systems in Burger Products

| | | Plant-Only Ingredients, Ingredient |
|---|---|---|
| | Plant-only | Combinations of Plant-only |
| | Burger Product | Composition or Replacement |
| | Essential | Systems Enabling Functionality |
| | Ingredients and | within the Burger Product |
| Function | Combinations | Composition |
| Emulsifier | One or more oils | Sunflower oil is primarily (85%) |
| | providing high | unsaturated fatty acids comprising 14- |
| | levels of MUFAs, | 43% oleic acid and 44-75% linoleic acid, |
| | omega 3 fatty | the latter, which results in the oil's lower |
| | acids, & MCTs | freezing point, and contributes to the |
| | (sunflower oil, | lower freezing points of products in |
| | coconut oil, | which sunflower oil is added. |
| | flaxseed oil, rice | Coconut oil, in contrast, is ~87% |
| | bran oil, or other | saturated fatty acids, lauric acid |
| | oil substitute | accounting for ~49% of the saturated |
| | exhibiting the | fats. Other saturated fatty acids include |
| | same or similar | myristic, palmitic, stearic, oleic, capric |
| | properties and | and caprylic acids. |
| | functionality) | Flaxseed comprises ~35-45% oil and |
| | | 20-30% protein. The oily portion |
| | | consists of 9-10% saturated fatty acids |
| | | (palmitic and stearic), ~20% |
| | | monounsaturated fatty acids (mainly |
| | | oleic acid), and more than 70% alpha- |
| | | linolenic fatty acids acid. |
| | | Rice bran oil consists of ~74% |
| | | unsaturated fatty acids (~30% linoleic |
| | | acid, ~44% oleic acid), and the remaining |
| | | ~23% are saturated fatty acids. |
| Thickening | Thickeners and | Chickpea fractions (starch, proteins) |
| agents / | binding agents (one | function as binders and are also a protein |
| binding agent | or more of | source (72-85% are globulins and |
| | chickpeas, oat | albumin). Protein matrices formed have |
| | fiber, passion fruit, | the ability to hold water and fat. Their |
| | aquafaba, sugar | binding properties are also attributable to |
| | beet pectin, and/or | water soluble and insoluble |
| | substitute(s) with | carbohydrates: cellulose, starch and |
| | the same or similar | hemicellulose. |
| | functionality and | Soluble carbohydrates have higher water |
| | properties) | binding capacities, and water soluble- and |
| | | insoluble polysaccharides also absorb oil. |
| | | Oat fiber retains water, decreases cooking |
| | | losses and has neutral flavor. Oats have a |
| | | fiber type of β-glucan, a soluble fiber |
| | | accounting to 4%. It depicts functional |
| | | properties as a potential binding agent. Oat |
| | | fiber provides the flavor, texture and |
| | | mouthfeel of fat. |
| | | Passion fruit has a high proportion (52%) |
| | | of insoluble dietary fiber (cellulose, |
| | | hemicellulose, and pectin), which |
| | | contributes to strong fat and water |
| | | retaining abilities. The fruit contains |
| | | moderate length cellulose fibers, |
| | | contributing to a moderate ability to retain |
| | | fat. Cellulose interlinks with |
| | | hemicellulose and forming a fiber net, |
| | | increasing the surface area of individual |
| | | fibers, and contributing their water and oil |
| | | retention properties. |
| Texturizer / | Modified starch | Tapioca starch is an excellent thickener, |
| gelling agent | replacement | binder, texturizer and stabilizer. |
| | system (one or | Sometimes called tapioca flour, this starch |
| | more of tapioca | originates from the cassava plant. |
| | starch, faba bean, | Gelatinized (tapioca) starch can hold a |
| | sorghum starch, | significant amount of water, which helps |
| | quinoa starch, rice | improve the texture of many food |
| | starch or substitute | products, including burgers and burger |
| | exhibiting the same | mixes. |
| | or similar | The faba bean protein is glossy and sticky, |
| | functionality and | and is an important emulsifier, foam |
| | properties) | stabilizer, and contributes to gel |
| | | formation. Its protein constituents include |
| | | globulin and albumin accounting for ~25- |
| | | 30% of its content; these proteins do not |
| | | contribute as much as the other |
| | | constituents to the gelling capacity. |
| | | The quinoa starch is relatively low in |
| | | amylose content (e.g., 11%), and has very |
| | | small granules (1 to 3 μm). The starch has |
| | | unique properties such as low pasting |
| | | temperature, high freeze-thaw stability, |
| | | and water holding capacity. The protein |
| | | from quinoa flour helps provide structure |
| | | and shape to the system. The protein and |
| | | starch both contribute to the gelling |
| | | property. |
| | | Sorghum starch consists mainly |
| | | amylopectin and amylose. While heating, |
| | | the gelatinization of starch occurs due to |
| | | hydrogen bonds being broken within the |
| | | starch granule due to water influx, which |
| | | results in granular swelling, increasing |
| | | viscosity, which thickens and texturizes |
| | | the food product. |
| Shelf life | Plant only shelf life | Garlic (Allium sativum) is one of the |
| extender; | extenders (any one | commonly used plants to enhance flavor. |
| preservative, | or more of herbs | It produces a wide spectrum of actions |
| flavoring | and spices, | which have led to its use as an |
| agent, | including garlic | antibacterial, antifungal, and antioxidant |
| stabilizer | extract, Himalayan | agent. The presence of allicin, a sulfur- |
| | pink salt; black | containing compound, is responsible for |
| | pepper, oregano, | the antimicrobial effects. |
| | bay laurel and/or | Himalayan pink salt contains substantially |
| | any substitute(s) | higher levels of calcium, iron, magnesium, |
| | that exhibit the | manganese, potassium, aluminum, barium, |
| | same or similar | silicon, and sulfur, but lower levels of |
| | functionality and | sodium compared to the white table salt |
| | properties) | Black pepper, Piper nigrum, has piperine |
| | | in higher amounts that enables the |
| | | antimicrobial activity. Terpenes and |
| | | flavonoids also contribute to its activity. |
| | | The essential oil content in black pepper |
| | | mainly consists of caryophyllene (30.3%) |
| | | and limonene (12.12%), both of which |
| | | also contribute to its antimicrobial |
| | | activity. |
| | | Oregano, Origanum vulgare, along with |
| | | its flavor imparting action, contributes to |
| | | antimicrobial and antioxidant properties. |
| | | The major components of oregano |
| | | essential oil are carvacrol, β-fenchyl |
| | | alcohol, thymol, and γ-terpinen. These |
| | | compounds have a free radical |
| | | scavenging effect contributing to |
| | | enhanced shelf life. |
| | | Bay leaf contains 1.3% essential oils that |
| | | contribute to both flavor and shelf life |
| | | enhancement. These oils include primarily |
| | | eucalyptol (45%) but also other terpenes |
| | | (~12%), terpinyl acetate (8-12%), |
| | | sesquiterpenes (3-4%), methyl eugenol |
| | | (3%), and smaller amounts of other α- and |
| | | β-pinenes, phellandrene, linalool, |
| | | geraniol, terpineol and lauric acid. These |
| | | compounds exhibit radical scavenging and |
| | | antimicrobial activity. |
| Flavoring | Umami flavor | Meat and other animal-based products can |
| agent/ | source(s) (one or | be replaced in some food products with |
| umami | more of shitake and | one or more types of mushrooms without |
| flavor | other mushroom | compromising flavor, and can improve |
| | types, onions, | nutritional quality by reducing sodium, |
| | tomatoes, garlic, | calories, saturated fat, and cholesterol |
| | lotus stalk, salt, | content. Mushrooms impart an “umami” |
| | and/or any | flavor because of their flavor-enhancing |
| | substitute(s) for | compounds, most noticeably the eight |
| | these exhibiting the | carbon (C8) volatile compounds. Among |
| | same or similar | all C8 compounds, the most important for |
| | functionality and | mushroom flavor are oct-1-en-3-ol, octan- |
| | properties) | 3-ol, octan-3-on and oct-1-en-3-on. |
| | | Onion (Allium cepa L.) contains high |
| | | levels of flavonoids that enhance the |
| | | flavor of food products. Onions contribute |
| | | to the umami flavor of food with their |
| | | high glutamic acid content (~25 to |
| | | 50 mg/100 g). |
| | | Tomatoes impart a unique flavor, the |
| | | result of a complex mix and interaction |
| | | among sugars, acids, and volatile |
| | | compounds. They also are high in |
| | | glutamate (~250 mg/100 g). |
| Flavorants, | One or more | Paprika oleoresin contains a number of |
| flavor | flavorants, flavor | carotinoids and pigments, including, |
| enhancers, | enhancers, | among others, capsanthin and capsorubin, |
| nutraceutical | nutraceuticals (one | which are strong antioxidants. Paprika is |
| | or more of herbs | low in capsaicin, the pungent (hot) |
| | and spices such as | compound found in red peppers. |
| | cumin, paprika, | Methoxypyrazines” in paprika are |
| | coriander, black | responsible for its vegetative flavor. The |
| | pepper, onion, or a | sweetness of paprika comes from a sugar |
| | substitute(s) that | content (up to 6%). Paprika has important |
| | exhibit the same or | bioactive compounds such as carotenoids, |
| | similar functionality | quercetin glycosides, and luteolin, all of |
| | and properties) | which exhibit high antioxidant activity. |
| | | Onions (Allium cepa L.) contain |
| | | phytonutrients such as: flavonoids, |
| | | fructooligosaccharides (FOS), thiosulfide |
| | | and other sulfur compounds, which are |
| | | recognized as important elements of |
| | | highly nutritional molecules. Quercetin |
| | | is the main flavonoid present in onions, |
| | | exhibiting antioxidant and antimicrobial |
| | | properties. |
| | | Black pepper (P. nigrum) contains |
| | | numerous flavor compounds and has |
| | | antimicrobial and antioxidant properties. |
| | | The primary volatile flavor compounds |
| | | include terpenes: monoterpene |
| | | hydrocarbons (59.2-80.1%) and |
| | | sesquiterpene hydrocarbons (17.0-37.7%) |
| | | while oxygenated terpenoids accounted for |
| | | about 1.3-2.7%. Key odorants of black |
| | | pepper are α- and β-pinene, myrcene, α- |
| | | phellandrene, limonene, linalool, methyl |
| | | propanal, 2- and 3-methylbutanal, butyric |
| | | acid, germacrene, and 3-methylbutyric |
| | | acid. The spiciness of black pepper comes |
| | | from Piperine. Germacrene is potent, |
| | | spicy, warm and has a sweet aroma. In |
| | | contrast, limonene is sweet, orange, citrus |
| | | and terpy. The essential oil content in |
| | | black pepper mainly consists of |
| | | caryophyllene (30.3%) and limonene |
| | | (12.12%) also contribute to antioxidant |
| | | activity. |
| | | Cumin is a seed spice belonging to the |
| | | family Umbelliferae. Cumin and products |
| | | flavored by cumin are used in food |
| | | products and perfumery. Cumin contains |
| | | ~2.3 to 4.8% of volatile oils. The |
| | | characteristic odor of cumin is mainly |
| | | due to the aldehydes present in the seeds, |
| | | namely, cuminaldehyde (45-50%), p- |
| | | menth-3-en-7-al and p-menth-1,3-dien-7- |
| | | al. Other major compounds present in |
| | | cumin contributing its distinct flavor |
| | | include: cuminal (8-17%), β-pinene (22- |
| | | 27%), β-myrcene (1.3-1.75%), ρ-cymene |
| | | (23-39%), γ-terpinene (11-27%), and ρ- |
| | | mentha-1,4-dien-7-ol (1.0-5.5%). |
| | | Coriander, Coriandrum sativum, has a |
| | | characteristic flavor is due to terpenes. |
| | | The essential oils present in oil glands in |
| | | the mericarp and the linalool, with its |
| | | floral and pleasant scents also contribute |
| | | to flavor enhancement. |
| | | Phenolics compounds present in the |
| | | coriander seeds such as gallic acid, caffeic |
| | | acid, ellagic acid, quercetin, kaempferol |
| | | contribute to the antioxidant activity. |
| Thickener, | MC replacement | Pea fiber contains insoluble fibers and |
| Binding agent, | system: ingredients | higher protein content, which contribute to |
| Stabilizer | from all five | its ability to hold water. The combination |
| | categories (proteins; | of protein and fiber also leads to the |
| | fibers from whole | higher oil absorbing capacity. Peas contain |
| | grains, fruits, seeds | a high amylose starch content (25-29%) |
| | and vegetables; | that enables it to bind water and oil. |
| | starches; and | Oat fibers retain water, decreases cooking |
| | vegetable binders) | loss, and it has a neutral flavor. Oats |
| | and/or any | contain 4% (by weight) of β-glucan, a |
| | substitute(s) that | soluble fiber with potential binding |
| | exhibit the same or | abilities. Oat fiber provides flavor, texture, |
| | similar properties | and mouthfeel of fat. In addition, β-glucan |
| | and functionalities | also contains hydrocolloids that provide |
| | | emulsion stability, modifying the gelation |
| | | process and increasing viscosity. β-glucan |
| | | forms a porous network in a protein-gel |
| | | matrix, e.g., holding fat globules in the |
| | | burger system. |
| | | Chickpeas contain starch and protein, and |
| | | act as binder and stabilizer. Chickpea |
| | | proteins include globulins and albumin, |
| | | which act as binding proteins; these |
| | | binding proteins constitute 72-85% of the |
| | | weight of the chickpea, and function as |
| | | thickeners and binders by forming protein |
| | | matrices that hold water and fat. |
| | | Quinoa starch is relatively low (e.g., 11%) |
| | | in amylose and appears as small granules |
| | | (1 to 3 μm). Quinoa starch has unique |
| | | properties: low pasting temperature, high |
| | | freeze-thaw stability, and water holding |
| | | capacity. The Quinoa starch granules are |
| | | small, polygonal, and in the range of 0.5- |
| | | 3 μm; they function as a stabilizer for |
| | | creating pickering emulsions. The proteins |
| | | from quinoa flour help provide structure |
| | | and shape to the food product. |
| Hydro | Gum replacement | The main fraction of quince seed gum are |
| Colloids- | system(s) | high-molecular-weight polysaccharides, |
| gelling, | (categories 1, 2 | the most abundant among them which is |
| emulsifier, | and/or 3) | d- Xylan, with many glucuronic acid |
| stabilizer, | (Category 2: one or | residues. The presence of proteins in |
| sequestrant | more of quinoa | quince seed gum (2.2%) affects the |
| | starch, rice starch, | interfacial tension at the oil-water |
| | chickpea protein | interface and contributes to its ability to |
| | and starch and | act as an emulsifier. |
| | apple pomace | Almond is mainly composed of 92.36% |
| | (pectin) and/or | of polysaccharides (dry weight basis) with |
| | substitute(s) that | the major sugar composition comprising: |
| | exhibit the same or | arabinose (46.83%), galactose (35.49%) |
| | similar properties | and uronic acid (5.97%). It also contains a |
| | and functionality) | small amount of protein (2.45%) |
| | Gum replacement | Quinoa: starch is the main component (up |
| | system (categories | to 70% dry weight) of the quinoa grain. |
| | 1 and 3) are | Starch plays a crucial role in functional |
| | discussed in | properties of quinoa and related food |
| | separate disclosures, | products. The small starch granules (~1- |
| | although the | 3 μm) exhibit a low amylose content |
| | preferred | versus most of the other starches. |
| | ingredients of each | Chickpea starch and protein form matrices |
| | can be found in | that hold water contributing to gelling |
| | Table 6 above. | capacity. |
| | | Mesquite proteins are a complex |
| | | carbohydrate and protein mix and is |
| | | comprised of D-galactose, L-arabinose, D- |
| | | glucuronate, D-mannose and D-xylose. |
| | | Apple pomace (pectin) is a low methyl |
| | | cellulose-containing pectin, and forms a |
| | | thermo-irreversible gel, remaining in a gel |
| | | consistency even at high temperatures that |
| | | would normally melt pectin. Pectin aids in |
| | | the formation of smaller droplet size |
| | | emulsions, showing higher stability and |
| | | forming a gel-like consistency. The action |
| | | of the insoluble fibers in pectin maintain |
| | | their stability in emulsions through |
| | | pickering mechanism and through |
| | | network formation in the continuous |
| | | phase; this may be favored by stabilization |
| | | of proteins and pectin in the soluble |
| | | fraction. |
| Flavoring | Flavor enhancer, | Nutritional yeast is a food additive made |
| agent | nutritional yeast | from a single-celled organism, |
| | (one or more of | Saccharomyces cerevisiae, a member of |
| | nutritional yeast, | the fungi kingdom. This yeast is grown on |
| | cashews and/or any | molasses and then harvested, washed, and |
| | substitute(s) for | dried with heat to kill or deactivate it. |
| | either one that | Cashews contain esters (methyl 3-methyl |
| | exhibits the same or | butanoate, ethyl 3-methyl butanoate, |
| | similar functionality | methyl butanoate, ethyl butanoate, ethyl |
| | and properties) | trans-2-butenoate and methyl 3-methyl |
| | | pentanoate) which impart a sweet, fruity |
| | | taste and aroma. |
| Leavening | Leavener | Apple cider vinegar is the fermented juice |
| agent(s) | replacement | of crushed apples, containing acetic acid, |
| | system (ingredients | which contributes to the leavening action |
| | from five | in food products. |
| | categories, | Dried plums contain about 2% naturally |
| | including one or | occurring malic acid, which serves as the |
| | more of plum | natural acid component of chemical |
| | powder, apple cider | leavening systems. Dried plums can also |
| | vinegar, vegan | act as a natural preservative, inhibiting |
| | buttermilk, and/or | microbial spoilage. |
| | any substitute(s) | Vegan buttermilk is made by combining |
| | that exhibit the | almond milk with acidulants. The high fat |
| | same or similar | content combined with acids result in |
| | functionality and | curdling. |
| | properties) | |
| Lipid | Lipid peroxidation | Black pepper (P. nigrum) with piperine as |
| peroxidation | inhibitors (one or | an active ingredient, holds rich |
| inhibitor, | more of black | phytochemistry that also includes volatile |
| antioxidant, | pepper, bay leaf, | oil, oleoresins, and alkaloids. Black |
| flavor enhancer | cumin, and/or any | pepper oleoresins impart taste and exhibit |
| | substitute(s) that | antioxidant properties. They are also used |
| | exhibit the same or | as a colorant and a food preservative |
| | similar functionality | because of their antimicrobial properties. |
| | and properties) | β-Caryophyllene, limonene, β-pinene, α- |
| | | pinene, δ-3-carene, sabinene, and myrcene |
| | | are the main components of this oil. |
| | | Bay leaves show radical scavenging |
| | | activity due to the presence of |
| | | sesquiterpene lactones, alkaloids, and |
| | | glycosylated flavonoids. The |
| | | kaempferol C-glycoside is the major |
| | | contributor to antioxidant properties. |
| | | Cumin's antioxidant activity is correlated |
| | | with the presence of high polyphenols, |
| | | mainly flavonoids. The essential oils |
| | | present—carvacrol, anethole, and |
| | | terpineol—also contribute to the function |
| | | of radical scavenging. |
| Color | One or more | Leghaemoglobin is a protein that binds |
| retention, | sources of | oxygen and is found in the root nodules of |
| coloring | leghaemoglobin | leguminous plants; it is often used as an |
| agent, nitrite | (one or more of | ingredient in some plant-based meat |
| replacement | beets, red radishes | substitutes. |
| | and/or any | Red beet—B. vulgaris—is one of the top |
| | substitute(s) that | ten most potent antioxidant-rich |
| | exhibit the same or | vegetables. Betalains (including |
| | similar functionality | betanin/betanidin) exhibit high antioxidant |
| | and properties) | activity. Red radish and beet powders |
| | | exhibit antioxidant activity and are high in |
| | | nitrates. Radish powder in particular |
| | | prevents meats and meat substitutes from |
| | | changing color. |

Table 9 below, provides a preparation of the ingredient of the Plant-only composition/gum replacement system against each category.

TABLE 9
Preparation method of each of the ingredient of the Plant-only
composition/gum replacement system against each category:

| Ingredient | Preparation method |
|---|---|
| Quinoa flour | Quinoa that has been rinsed and drained is spread out on a |
| (starch, protein) | cloth for traditional drying before being dry-roasted for three to |
| | five minutes, or until it is entirely dry. The dried quinoa is |
| | transferred to a blender and ground into a fine flour, followed |
| | by sieving. |
| Rice starch | Rice flour is mixed with 0.05M aqueous alkali in the ratio of |
| | 1:5 and then stirred at 25 C. for 3 hours and then centrifuged at |
| | 5500~g for 10 min. The yellow-opaque sediment layer is |
| | scraped off with a spatula while the supernatant is discarded. |
| | Once the starch residue has been cleaned with alkali, it is again |
| | suspended in water and filtered through a 100-mesh screen |
| | before being agitated for one hour and centrifuged. After |
| | washing, the starch residue underwent pH 7.0 for |
| | neutralization. This is followed by centrifugation and one hour |
| | of room-temperature stirring. The starch sediment undergoes |
| | two water washes before air drying. |
| Apple pomace | Apple pomace is obtained from the belt juice pressing. Frozen |
| (pectin) | apple pomace is exposed to drying treatments with forced air |
| | drying at 40° C. at 110° C. . Using a laboratory mill with a 0.5 |
| | mm screen, partially dried pomace is converted into flour. |
| Chickpea flour | Chickpeas are cleaned, soaked overnight or a minimum of 8 |
| (starch, protein) | hours. Then the chickpeas are dried by placing them on a large |
| | dehydrator tray in the oven set at 50° C. for 12 hours. After |
| | which, they are ground in a high-speed food processor/blender. |

### Applications of the Plant-Only Composition/Gum Replacement System:

Applications of the plant-only composition/gum replacement system are ice creams, pasta, processed cheese, tomato ketchup, soups, pastry ices, soft viscous candies, fruit-based and membrane-coated items, burgers, sausages, burger mixes, cakes, chocolate bars, pancake mixes etc.

FIG. 2 illustrates a flow diagram of a process of preparing a plant-only composition for a food product according to some embodiments herein. At a step 202, dried powdered/ingredients of (A) about 5-20% weight by weight of Quinoa flour and/or like any one or more of licorice root flour, etc., (B) about 15-25% weight by weight of a Rice starch and/or like any or more of sorghum starch, etc., (C) about 20-30% weight by weight of Apple pomace and/or like any or more of jujube pomace, etc., and (D) about 10-25% weight by weight of Chickpea flour and/or like any one or more of pea flour, etc., are mixed together for 30 seconds to 1 minute. At a step 204, the mixture then undergoes a low order heat treatment to form a gel at a temperature of between 60° C. and 105° C. At a step 206, using a blender or a bowl cutter, all of the ingredients in the Plant-only composition/gum replacement system are incorporated with the whole formulation of the intended food product in a gel or dough.

While specific embodiments of the present disclosure have been shown and described in detail to illustrate the inventive principles, it will be understood that the present disclosure may be embodied otherwise without departing from such principles.

While considerable emphasis has been placed herein on the specific features of the preferred embodiment, it will be appreciated that many additional features can be added and that many changes can be made in the preferred embodiment without departing from the principles of the present disclosure. These and other changes in the preferred embodiment of the present disclosure will be apparent to those skilled in the art from the present disclosure herein, whereby it is to be distinctly understood that the foregoing descriptive matter is to be interpreted merely as illustrative of the present disclosure and not as a limitation.

The use of the expression “at least” or “at least one” suggests the use of one or more elements or components, as the use may be in the embodiment of the present disclosure to achieve one or more of the desired objects or results. While certain embodiments of the present disclosure have been described, these embodiments have been presented by way of example only, and are not intended to limit the scope of the present disclosure. Variations or modifications to the formulation of this present disclosure, within the scope of the present disclosure, may occur to those skilled in the art upon reviewing the present disclosure herein. Such variations or modifications are well within the spirit of this present disclosure.

Reference throughout this specification to “some embodiments”, “an embodiment”, or similar language means that a particular feature, structure, or characteristic described in connection with the embodiment is included in at least one embodiment of the present disclosure. Thus, appearances of the phrases “in some embodiments”, “in an embodiment” and similar language throughout this specification may, but do not necessarily, all refer to the same embodiment.

It should be understood that the figures shown above highlighting the functionality and advantages of the present disclosure are presented for example purposes only. The present disclosure is sufficiently flexible and configurable, such that it may be utilized in ways other than that shown in the figures.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A plant-only composition for a food product, comprising:
about 1% to about 30% weight by weight of one or more plant-derived protein and starch sources;
about 5% to about 35% weight by weight of one or more plant-derived cereal starch;
about 10% to about 40% weight by weight of one or more pectin sources; and
about 1% to about 35% weight by weight of one or more legume sources, wherein the plant-only composition substitutes a gum ingredient in the food product.

2. The plant-only composition of claim 1, wherein the one or more plant-derived protein and starch sources comprises at least one of quinoa flour, licorice root flour, almond flour, bamboo seeds flour, Jackfruit seed flour, oats flour, Arrowroot powder, Yam flour, mung bean flour, soy flour, or a combination thereof.

3. The plant-only composition of claim 2, wherein the quinoa flour comprises (i) protein that provides structure to the food product and (ii) starch which has about 11% amylose content with small granules ranging from 1-3 micrometres (μm), wherein the quinoa flour has low pasting temperature and high freeze-thaw stability and acts as a thickener, wherein the quinoa flour comprises saponins that has antioxidant activity.

4. The plant-only composition of claim 1, wherein the one or more plant-derived protein and starch sources present in the plant-only composition ranges from about 5% to about 20% weight by weight of the composition.

5. The plant-only composition of claim 1, wherein the one or more plant-derived protein and starch sources present in the plant-only composition ranges from (i) about 1% to about 5% weight by weight of the composition, (ii) about 5% to about 10% weight by weight of the composition, (iii) about 5% to about 20% weight by weight of the composition, (iv) about 10% to about 20% weight by weight of the composition, (v) about 15% to about 20% weight by weight of the composition, (vi) about 20% to about 25% weight by weight of the composition, or (vii) about 25% to about 30% weight by weight of the composition.

6. The plant-only composition of claim 1, wherein the one or more plant-derived protein and starch sources has a gelatinization/pasting temperature of about 68.6° C. to about 69.3° C., a peak viscosity of about 0.1 and about 0.9 pascal seconds (Pa·s) at a shear rate of 115 inverse second (s⁻¹), a water holding capacity of about 415.13% to about 595.26%, an emulsion stability of about 35% to about 90%, a swelling power ranging from 20.76% to 26.92%, a moisture content of about 12.6%, a bulk density of about 0.72 gram per millilitre (g/mL), an emulsion capacity of about 100%, a foaming capacity of about 17%, a water soluble index of about 11.5% to about 13% and a peak viscosity of about 1696 millipascal seconds (mPa·s) to about 2560 mPa·s.

7. The plant-only composition of claim 1, wherein the one or more plant-derived cereal starch comprises at least one of rice starch, sorghum starch, maize starch, wheat starch, barley starch, pearl millet starch, ragi flour, finger millet starch, oats starch, rye starch, or a combination thereof.

8. The plant-only composition of claim 7, wherein the rice starch comprises amylose and amylopectin in a ratio of 20:80 and has a particle size ranging from 1 to 100 μm.

9. The plant-only composition of claim 1, wherein the one or more plant-derived cereal starch present in the plant-only composition ranges from about 15% to about 25% weight by weight of the composition.

10. The plant-only composition of claim 1, wherein the one or more plant-derived cereal starch present in the plant-only composition ranges from (i) about 5% to about 10% weight by weight of the composition, (ii) about 10% to about 15% weight by weight of the composition, (iii) about 15% to about 20% weight by weight of the composition, (iv) about 15% to about 25% weight by weight of the composition, (v) about 20% to about 25% weight by weight of the composition, (vi) about 25% to about 30% weight by weight of the composition, or (vii) about 30% to about 35% weight by weight of the composition.

11. The plant-only composition of claim 1, wherein the one or more plant-derived cereal starch has a gelatinization/pasting temperature of about 68° C. to about 72° C., a peak viscosity of about 1296 centipoise (cP) to about 3348 cP, a water holding capacity of about 2.42 grams water per gram (g/g) to about 3.35 g/g, an amylose content of about 14% to about 30% and a swelling power ranging from 3.3 g/g to 8.8 g/g, a molecular weight of about 5.4×10⁷ gram per molar (g/mol) and a particle size distribution ranging about 1 micron (μm) to about 100 μm.

12. The plant-only composition of claim 1, wherein the one or more pectin sources comprises at least one of apple pomace, jujube pomace, redcurrant pectin, blackberry pectin, strawberry pectin, orange pomace, dragon fruit peel pectin, raspberry pectin, or a combination thereof.

13. The plant-only composition of claim 12, wherein the apple pomace comprises methyl cellulose pectin that forms a thermo-irreversible gel which remains gelled even when heated to its melting temperatures, wherein the apple pomace has insoluble fibers that maintain emulsion stability through a pickering mechanism and network formation in the continuous phase by stabilization of proteins and pectins in the soluble fraction.

14. The plant-only composition of claim 1, wherein the one or more pectin sources present in the plant-only composition ranges from about 20% to about 30% weight by weight of the composition.

15. The plant-only composition of claim 1, wherein the one or more pectin sources present in the plant-only composition ranges from (i) about 10% to about 15% weight by weight of the composition, (ii) about 15% to about 20% weight by weight of the composition, (iii) about 20% to about 25% weight by weight of the composition, (iv) about 25% to about 30% weight by weight of the composition, (v) about 20% to about 30% weight by weight of the composition, (vi) about 30% to about 35% weight by weight of the composition, or (vii) about 35% to about 40% weight by weight of the composition.

16. The plant-only composition of claim 1, wherein the one or more pectin sources has an emulsion stability of about 35% to about 80%, an oil holding capacity of 2.97 grams of oil per gram (g/g) to about 11 g/g, a water holding capacity of about 3 grams water per gram (g/g) to about 17 g/g, a pH of about 3.9, a molecular weight of about 2.64×10⁵ gram per molar (g/mol) to about 3.86×10⁵ g/mol, a methoxyl content of about 4.2% to about 4.7% and a galacturonic acid content of about 50.4%.

17. The plant-only composition of claim 1, wherein the one or more legume sources comprises at least one of chickpea flour, pea flour, lupine flour, soy flour, pigeon pea, pinto beans flour, red lentils flour, lima beans, navy bean, mung bean, black gram flour, yellow pea flour, or a combination thereof.

18. The plant-only composition of claim 17, wherein the chickpea flour comprises (i) proteins comprising albumins and globulins, and (ii) carbohydrates, wherein the proteins and carbohydrates of chickpea flour form matrices with higher water holding capacity, oil binding capacity, emulsion stability and emulsion activity than the starch fractions.

19. The plant-only composition of claim 1, wherein the one or more legume sources present in the plant-only composition ranges from about 10% to about 25% weight by weight of the composition.

20. The plant-only composition of claim 1, wherein the one or more legume sources present in the plant-only composition ranges from (i) about 1% to about 5% weight by weight of the composition, (ii) about 5% to about 10% weight by weight of the composition, (iii) about 10% to about 15% weight by weight of the composition, (iv) about 10% to about 20% weight by weight of the composition, (v) about 10% to about 25% weight by weight of the composition, (vi) about 15% to about 20% weight by weight of the composition, (vii) about 20% to about 25% weight by weight of the composition, (viii) about 25% to about 30% weight by weight of the composition or (ix) about 30% to about 35% weight by weight of the composition.

21. The plant-only composition of claim 1, wherein the one or more legume sources has a gelatinization/pasting temperature of about 60° C. to about 80° C., a peak viscosity of about 1107 cP to about 2173 cP, a water holding capacity of about 1.81 grams water per gram (g/g) to about 2.63 g/g, an emulsion stability of about 35% to 90%, a swelling power of about 1.05 g/g to about 21 g/g, a moisture content of about 9.6%, a bulk density of about 410 kilogram per meter cube (Kg/m3) to about 510 Kg/m3, a porosity of about 65% to about 71%, a gelation concentration of about 10% to about 14% and an oil absorbing capacity of about 3 g/g to about 5.74 g/g.

22. The plant-only composition of claim 1, wherein the food product comprises ice cream, pasta, processed cheese, tomato ketchup, soups, pastry ices, soft viscous candies, fruit-based and membrane-coated items, burgers, burger mixes, sausages, cakes, chocolate bars, pancake mixes, Traditional Burger Products, a baked good, a plant-only burger products, or another food product.

23. The plant-only composition of claim 1, wherein the plant-only composition comprises
about 5% to about 20% weight by weight of one or more plant-derived protein and starch sources;
about 15% to about 25% weight by weight of one or more plant-derived cereal starch;
about 20% to about 30% weight by weight of one or more pectin sources; and
about 10% to about 25% weight by weight of one or more legume sources, wherein the plant-only composition substitutes a gum ingredient in the food product.

24. The plant-only composition of claim 1, wherein the plant-only composition comprises
about 5% to about 20% weight by weight of quinoa flour;
about 15% to about 25% weight by weight of rice starch;
about 20% to about 30% weight by weight of apple pomace; and
about 10% to about 25% weight by weight of chickpea flour, wherein the plant-only composition substitutes a gum ingredient in the food product.

25. The plant-only composition of claim 1, wherein the plant-only composition present in the food product ranges from about 0.05% to 3% weight by weight of the food product.

26. The plant-only composition of claim 1, wherein the plant-only composition present in the food product ranges from about 0.05% to about 25% weight by weight of the food product depending on the moisture content of the plant-only composition and that of the final food product.

27. The plant-only composition of claim 1, wherein the plant-only composition present in the food product ranges from about 0.1% to about 2% weight by weight of the food product.

28. A food product, comprising:
about 10% to about 15% weight by weight a plant-only composition, wherein the plant-only composition comprises
about 1% to about 30% weight by weight of one or more plant-derived protein and starch sources;
about 5% to about 35% weight by weight of one or more plant-derived cereal starch;
about 10% to about 40% weight by weight of one or more pectin sources; and
about 1% to about 35% weight by weight of one or more legume sources, wherein the plant-only composition substitutes a gum ingredient in the food product.

29. The food product as claimed in claim 28, wherein the food product comprises
about 10% to about 20% weight by weight of one or more protein sources;
about 5% to about 10% weight by weight of a plant-derived methyl cellulose replacement composition;
about 10% to about 15% weight by weight of one or more plant-derived modified starches;
about 10% to about 12% weight by weight of one or more plant-derived oils; and
about 0.5% to about 1% weight by weight of a plant-derived leavener replacement composition.

30. The food product as claimed in claim 29, wherein the food product comprises
about 1% to about 2% weight by weight of one or more plant-derived shelf life extenders;
about 0.5% to about 2% weight by weight of a plant-derived umami flavor;
about 0.5% to about 1% weight by weight of one or more plant-derived flavorants/flavor enhancers, or nutraceuticals;
about 1% to about 2% weight by weight of a second plant-derived flavor enhancer;
about 0.5% to about 2% weight by weight of one or more mineral salts;
about 5% to about 10% weight by weight of one or more plant-derived binding agents;
about 1% to about 2% weight by weight of one or more plant-derived leghemoglobin sources; and
about 0.5% to about 2% weight by weight of one or more plant-derived lipid peroxidation inhibitors.

31. The food product of claim 29, wherein the one or more protein sources comprises at least one of pea, mushroom, quinoa, chickpeas, or a combination thereof.

32. The food product of claim 29, wherein the plant-derived methyl cellulose replacement composition comprises at least one of proteins, fiber from whole grains, fruits, seeds, vegetables, starches, vegetable binders, or a combination thereof.

33. The food product of claim 29, wherein the one or more plant-derived oils comprises at least one of sunflower oil, coconut oil, flaxseed oil, rice bran oil, other oil comprising at least one of Omega-3 fatty acids, Monounsaturated fatty acids (MUFA), or Medium-chain triglycerides (MCTs), or a combination thereof.

34. The food product of claim 29, wherein the one or more plant-derived modified starches comprises at least one of tapioca starch, faba bean starch, sorghum starch, quinoa starch, or a combination thereof.

35. The food product of claim 29, wherein the plant-derived leavener replacement composition comprises at least one of plant-derived fibers, fruit pectins, fruit acids, plant-derived starches, cereal sources, or a combination thereof.

36. The food product of claim 29, wherein the plant-derived leavener replacement composition comprises at least one of plum powder, apple cider vinegar, vegan buttermilk, or a combination thereof.

37. The food product of claim 30, wherein the one or more plant-derived shelf life extenders comprises at least one of garlic, black pepper, oregano, bay laurel, or a combination thereof, wherein the plant-derived umami flavor comprises at least one of shitake and other mushrooms, tomatoes, garlic, lotus stalk, onions, salt, or a combination thereof, wherein the one or more plant-derived flavorants/flavor enhancers, or nutraceuticals comprises at least one of cumin, coriander, paprika, black pepper, or a combination thereof, wherein the second plant-derived flavor enhancer comprises at least one of nutritional yeast, cashew nuts, or a combination thereof, wherein the one or more mineral salts comprises at least one of Himalayan pink salt, sea salt, or a combination thereof, wherein the one or more plant-derived binding agents comprises at least one of chickpeas, oat fiber, aquafaba, sugar beet pectin, or a combination thereof, wherein the one or more plant-derived leghemoglobin sources comprises at least one of beets, soy, red radish, or a combination thereof, wherein the one or more plant-derived lipid peroxidation inhibitors comprises at least one of black pepper, bay leaf, cumin, or a combination thereof.

38. A plant-only gum replacement system for a food product comprising a plant-only composition, wherein said plant-only composition comprises:
about 1% to about 30% weight by weight of one or more plant-derived protein and starch sources;
about 5% to about 35% weight by weight of one or more plant-derived cereal starch;
about 10% to about 40% weight by weight of one or more pectin sources; and about 1% to about 35% weight by weight of one or more legume sources, wherein the plant-only composition substitutes a gum ingredient in the food product.
